(19) United States
(12) Patent Application Publication
(10) Pub. No.: US 2026/0349774 A1
(43) Pub. Date: Nov. 5, 2026

(54) LANGUAGE, PLATFORM AND INFRASTRUCTURE AGNOSTIC TENANT APPLICATION PROGRAMMING

(71) Applicant: Semut Technologies Pte Ltd, Singapore (SG)

(72) Inventor: Mansoor AHMED, Singapore (SG)

(21) Appl. No.: 19/120,693

(22) PCT Filed: Oct. 13, 2023
(86) PCT No.: PCT/SG2023/050693

§ 371 Date: Apr. 11, 2025

(30) Foreign Application Priority Data
Oct. 13, 2022 (SG) 10202251367K

(51) Int. Cl. G06F 9/455

(52) U.S. Cl. CPC G06F 9/45558; G06F 2009/45587

(57) ABSTRACT

Systems and methods for language, platform and infrastructure agnostic programming are provided. The method for platform and infrastructure agnostic programming includes identifying a plurality of components and nodes to be utilized by an application runtime to implement logical entities and manage methods of a general computing abstraction. The method further includes generating an application manager to expose an interface to a user to interact with the application runtime as part of an application instance and programming the application manager to manage activities of the application instance, the application manager using logical entities of a general computing abstraction to create and manage the application instance.

### PRIORITY CLAIM

This application claims priority from Singapore Patent Application No. 10202251367K filed on 13 Oct. 2022.

### TECHNICAL FIELD

The present invention relates generally to computer networks, and more particularly relates to language, platform and infrastructure agnostic tenant application programming.

### BACKGROUND OF THE DISCLOSURE

A software application (called an application or just “app”) is a processor executable program designed to carry out a specific task or solve a specific problem. Generally, most users of computing consume computing by way of using applications. For example, a user utilizes computational capacity of a computer by using a word processor. This is generally true whether the users are engineers who are using sophisticated applications for unsupervised machine learning or finance professionals using an accountancy software.

Desktop applications, when installed on a computing device, are meant to be used by a single user at a given time and are typically built for a specific platform (e.g., Microsoft Windows®) using a set of technologies that are best suited for addressing the requirements of the application on the given platform. However, developers of desktop applications may have to rewrite applications to run them on different platforms. Moreover, the platform and programming language combination may lack features or functionality required to build an application, thereby making it challenging to achieve application consistency across various platforms. In addition, updating desktop applications on all devices is usually a complex and time-consuming proposition. In many cases, organizations are required to update applications running on tens of thousands of devices and, in cases where updates to an application address a critical security vulnerability of the application, delay in updates could have serious adverse implications.

Mobile applications are the primary means users consume computing on their mobile computing devices. Mobile applications are relatively simple to develop when compared to desktop applications. In addition, there are frameworks available that aid mobile application developers in rapidly building applications. However, mobile applications are constrained by the resources available on a mobile computing device. Developers have to factor battery life, central processing unit (CPU), memory, storage and bandwidth while developing mobile applications.

In addition to desktop applications and mobile applications which are single tenant applications, Platform as a service (PAAS) and Software as a service (SAAS) are application licensing and delivery model in which multi-tenant applications are centrally hosted on remote servers, are accessible over a network like the internet and are designed to be accessed by plurality of users at a given time. Users use applications which may be running on any platform. However, each of the platforms presents its own advantages and problems for developing and using the applications. Building applications that run and behave uniformly over various platforms is time and capital intensive.

PAAS applications are generally applications that are used by software engineers to perform a specific task such as storing of structured, semi structured and unstructured data (databases), running a message queue or analyzing large amounts of data. SAAS applications are generally applications that address a specific need of a user like payroll management, course management, hospital management, or electronic marketplace. Knowledge of computer science and software engineering is generally not needed to use SAAS applications. When compared to desktop applications, PAAS and SAAS applications are relatively more complex to build. Building scalable systems is generally complex and requires software engineers skilled in the art of building scalable distributed systems.

However, there are a number of technical problems associated with PAAS and SAAS applications. Data of PAAS and SAAS applications is stored on service provider's servers and not the end user's servers which creates a major issue of data security and also data locality. Also, PAAS and SAAS service providers generally use cloud computing platforms for deploying their applications and thus face challenges like vendor lock-in due to the current fragmented nature of the cloud. Further, PAAS and SAAS applications can limit access to user's data. For example, users cannot access messages that were sent before a specific time on a messaging app or ask for one time extract of all the messages if they are on a basic subscription plan. Users will have to subscribe to a plan with higher cost to be able to access their own data. In addition, there is also a concern of user's data being retained or used for purposes not explicitly authorized by the user.

Apart from the technology challenges associated with these types of applications, there are issues involving sales and distribution of the applications and open-source software. Selling software globally to all types of clients like large corporations, mid-sized and small businesses, and individuals is a complex art that is generally practiced by large corporations or very well-funded startups. Thus, it is very difficult for a handful of engineers to build software and sell them to many types of clients with many types of infrastructure setups. Also, while there are thousands of open-source software applications, it is almost impossible for most users to use the applications reliably and at scale.

Thus, there is a need for systems, methods and products for language, platform and infrastructure agnostic application programming which overcome the drawbacks of present systems, methods and products and provides a robust, easy-to-use approach for building applications, selling and distributing applications globally and consuming such applications easily. Furthermore, other desirable features and characteristics will become apparent from the subsequent detailed description and the appended claims, taken in conjunction with the accompanying drawings and this background of the disclosure.

### SUMMARY

According to at least one embodiment of the present disclosure, a general computing abstraction is provided. The general computing abstraction includes logical entities and methods. The logical entities include one or more actions. The General Computing Abstraction enables a user to develop platform and infrastructure agnostic applications. The General Computing Abstraction also enables a user to program runtimes implementing the logical entities and the methods of the General Computing Abstraction on one of a plurality of platforms, infrastructures or devices. The runtimes enable installation and usage of applications written using the General Computing Abstraction.

According to another embodiment of the present disclosure, a method for programming cloud, platform and infrastructure independent managed services is provided. The method includes generating an application manager providing an interface to a user. The interface provides users a means to use the application's features. The method further includes utilization of a plurality of logical entities and methods specified by a general computing abstraction identified by the application manager. The application manager utilizes an interface provided by a runtime implementing the general computing abstraction and the application manager utilizes the logical entities to create and manage application instances. The application manager manages activities of the application instances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present disclosure.

FIG. 1 depicts an illustration of an application development and publishing process in accordance with present disclosure.

FIG. 2 depicts a flowchart illustrating a process of a client discovering and consuming applications in accordance with the present disclosure.

FIG. 3 depicts a flowchart illustrating a client discovering and consuming a MySQL application in accordance with the present disclosure.

FIG. 4 depicts a flowchart illustrating a client discovering and consuming a Wordpress application in accordance with the present disclosure.

FIG. 5, comprising FIGS. 5A and 5B, depicts typical PAAS and SAAS managed services, wherein FIG. 5A depicts an application manager build and FIG. 5B depicts one or more application images of components or nodes required for application service.

FIG. 6, comprising FIGS. 6A and 6B, depicts an application build of a MySQL application in accordance with the present disclosure, wherein FIG. 6A depicts the MySQL application manager build and FIG. 6B depicts application images of nodes required for the My SQL application service.

FIG. 7 depicts a diagram of a typical application manager utilizing general computing abstraction for PAAS and SAAS for creation and management of logical assets.

FIG. 8 depicts a diagram of an overview of a general computing abstraction for PAAS and SAAS in accordance with the present disclosure.

FIG. 9 depicts an illustration of communication between an application manager and a runtime in accordance with the present disclosure.

FIG. 10 depicts a diagram of logical entities and methods specified by a general computing abstraction for SAAS and PAAS in accordance with the present disclosure.

FIG. 11 depicts a diagram of runtime operation in accordance with the present disclosure.

FIG. 12 depicts a diagram of an overview of an interface of a MySQL application used by clients and using a general computing abstraction in accordance with the present disclosure.

FIG. 13 depicts a diagram of a runtime in accordance with the present disclosure.

FIG. 14 depicts a logical representation of a runtime in accordance with an aspect of the present disclosure.

FIG. 15 depicts a diagram of an application manager orchestrated by a runtime in accordance with the present disclosure.

FIG. 16 depicts a diagram of a client's use of an application manager to convert instructions to actions on physical assets in accordance with the present disclosure.

FIG. 17 depicts a logical representation of a worker orchestrate by a runtime in accordance with the present disclosure.

FIG. 18 depicts a high-level illustration of the development process, electronic repositories and their use by one or more runtimes in accordance with the present disclosure.

FIG. 19 depicts a logical representation of an electronic repository and marketplace in accordance with the present disclosure.

FIG. 20 depicts a flowchart of a single click process to launch an application instance in accordance with the present disclosure.

FIG. 21 depicts a flowchart of a single click process to launch a financial accounting application instance in accordance with the present disclosure.

FIG. 22 depicts a diagram of a developer developing and publishing an application then building and disseminating single click urls in accordance with the present disclosure.

FIG. 23 depicts launch configuration file in accordance with the present disclosure.

FIG. 24 depicts a flowchart of launching an application instance after execution of a single click url in accordance with the present disclosure.

FIG. 25 depicts a diagram of dependency and reusability of applications in accordance with the present disclosure.

FIG. 26 depicts a flowchart of a Wordpress application launch in accordance with the present disclosure.

FIG. 27 depicts a diagram of an invocation process in accordance with the present disclosure.

FIG. 28 depicts a flowchart of an invocation process with install in accordance with the present disclosure.

FIG. 29 depicts a diagram of an assignment of a globally unique ID in accordance with the present disclosure.

FIG. 30 depicts a diagram of an application update process in accordance with the present disclosure.

FIG. 31 depicts a flowchart of an application submission and publication process in accordance with the present disclosure.

FIG. 32 depicts a flowchart of a managed services pricing in accordance with the present disclosure.

FIG. 33 depicts a flowchart of managed services billing in accordance with the present disclosure.

FIG. 34 depicts a diagram of billing for a usage-based pricing model in accordance with the present disclosure.

FIG. 35 depicts a diagram of pricing models in accordance with the present disclosure.

FIG. 36 depicts a flowchart of a first process for usage of a fixed cost licensing model in accordance with the present disclosure.

FIG. 37 depicts a flowchart of a second process for usage of a fixed cost licensing model in accordance with the present disclosure.

FIG. 38 depicts a flowchart of a client's marketplace registration process in accordance with the present disclosure.

FIG. 39 depicts an illustration of a multi-tenant, multi-platform, multi-cloud, multi-region system in accordance with the present disclosure.

FIG. 40 depicts a diagram of a platform backend in accordance with the present disclosure.

FIG. 41 depicts a diagram of details of runtimes depicted in FIG. 39 in accordance with the present disclosure.

FIG. 42 depicts a flowchart of a process of converting a single tenant application into a managed service in accordance with the present disclosure.

FIG. 43 depicts a diagram of a multi-tenant platform capable installing and running managed services in accordance with an aspect of the present disclosure.

FIG. 44 depicts an illustration of a workflow of a user suing managed services on a runtime in accordance with the present disclosure.

FIG. 45, comprising FIGS. 45A and 45B, depicts a managed services' declaration of resources configuration files in accordance with the present disclosure, wherein FIG. 45A depicts a configuration file presenting a declaration of resource types and actions and FIG. 45B depicts a configuration file presenting a declaration of a MySQL managed service making available two resource types.

FIG. 46 depicts a flowchart of a process of installing a managed service on a runtime in accordance with the present disclosure.

FIG. 47 depicts a flowchart of a process for an administrator to create users and grant the users access to actions on resources made available by managed services in accordance with the present disclosure.

FIG. 48 depicts a flowchart of a process for authentication and authorization in accordance with the present disclosure.

And FIG. 49 depicts a diagram of two managed services and a gateway implementing a universal invocation interface in accordance with the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present disclosure to present language, platform and infrastructure agnostic single- and multiple-tenant application programming methods and systems for easy and rapid development of PAAS and SAAS applications, including software and platforms for developing, publishing and using SAAS and PAAS applications, the developed SAAS and PAAS applications being capable of being installed and used on any platform like public cloud, private data centers or desktops and the developed PAAS and SAAS applications being capable of being programmed in any programming language. In this connection, PAAS and SAAS applications may also be called cloud applications, cloud services, managed applications or managed services and any “managed service” built by anyone for any purpose including but not limited to private consumption, DevOps, automation or for publishing to marketplace are covered under the definition of SAAS and PAAS. The language, platform and infrastructure agnostic methods and systems in accordance with the present disclosure advantageously enable individual developers to build software quickly and distribute it globally such that corporations with private datacenters, businesses running on the cloud, startups and individuals using various platforms can use the developed applications effortlessly and competently.

In one embodiment in accordance with the present disclosure, a language and platform agnostic method and system for programming and offering single tenant applications as PAAS and SAAS services for use by plurality of users is provided. A “tenant” is a fundamental construct in SAAS and PAAS applications referring to the customers to whom the service or platform is made available (i.e., the customer signing up to use an application in an environment in accordance with the present disclosure are a “tenant” of the environment). As used herein, “tenant” refers to a single tenant and “multi-tenant” refers to multiple tenants which are registered/enabled to use an implementation of general computing abstraction, such as running applications using general computing abstraction, on a platform or on infrastructure available to them.

In another embodiment in accordance with the present disclosure, a method and system for general computing abstraction is provided, the abstraction providing means for development of managed services and runtimes where the managed services are cloud, platform and infrastructure agnostic. The runtimes capable of enabling installation and use of managed services are built using the general computing abstraction for a plurality of platforms, clouds or infrastructures.

In another embodiment in accordance with the present disclosure, language, platform and infrastructure agnostic methods and systems for general computing abstraction for rapid development of cloud, platform, and infrastructure agnostic PAAS and SAAS applications are provided, the said abstraction being an interface specification that is capable of being used for many purposes.

In another embodiment in accordance with the present disclosure, a method for developing private self-hosted PAAS and SAAS applications capable of being used privately on a closed network on any cloud, platform, or infrastructure instead of using centrally hosted publicly available PAAS and SAAS applications is provided.

In a further embodiment in accordance with the present disclosure, a method and system for running private PAAS and SAAS applications in any platform or infrastructure is provided, the method enabling organizations to have complete control of the data and the application while also enabling organizations to run latency sensitive applications within their own data centers.

In yet a further embodiment in accordance with the present disclosure, a method for achieving strong isolation within an organization is provided. The method is capable of being used for launching applications or application instances for each organizational unit which is independent and distinct from applications or application instances launched for other organizational units.

In a further embodiment in accordance with the present disclosure, a system that implements methods described in general computing abstraction is provided. The system is referred to as runtime hereafter and the runtime implements the general computing abstraction for a given platform, cloud or infrastructure. The runtime is capable of orchestrating logical assets on the underlying platform and infrastructure in a manner consistent with the behavior of the logical assets specified by the general computing abstraction. The logical assets may also be called virtual assets or logical entities. The runtime in accordance with the present disclosure further implements methods specified by the general computing abstraction on the underlying platform and infrastructure. The methods may also require the runtime to provide an interface which may be used by the managed services. The runtime further provides an interface capable of being used for configuring the runtime and applications running on the runtime.

In a further embodiment in accordance with the present disclosure, a method and system for live updates of runtimes without causing disruption to the running PAAS and SAAS applications and PAAS and SAAS application instances is provided.

In a further embodiment in accordance with the present disclosure, a method and system for live update of PAAS and SAAS services automatically without causing disruption to dependent services and running application instances is provided.

In another embodiment in accordance with the present disclosure, a method and system that enables development of services for deployment of applications are provided, thereby beneficially reducing the need for DevOps (Development Operations), where DevOps is the deep technical expertise of the platform on which PAAS and SAAS applications are deployed. The method and system further enable automation of DevOps and development of autonomous services.

In another embodiment in accordance with the present disclosure, a method and system for development and monetization of managed services based on open-source applications are provided. The method and system enable open-source communities for self-sustaining organizations while building open-source applications.

In another embodiment in accordance with the present disclosure, a method and system for development of secure managed services based on single tenant applications are provided. The said method and system advantageously require no changes to the single tenant applications for the development of managed service.

In a further embodiment in accordance with the present disclosure, a repository and an electronic storefront of PAAS and SAAS applications is provided. The PAAS and SAAS applications may either be private or public, and the public applications may either be open-source or closed-source. The repository is advantageously capable of being used by a plurality of users for publishing a plurality of SAAS and PAAS applications, and the repository is also capable of being used by a plurality of users and a plurality of runtimes.

In a further embodiment in accordance with the present disclosure, a method for assigning a globally unique ID to the PAAS and SAAS applications added to the repository and marketplace of applications programmed using the general computing abstraction is provided. The ID is capable of being used by any PAAS and SAAS application to invoke any endpoint of any PAAS and SAAS application.

In a further embodiment in accordance with the present disclosure, a method and system for secure universal invocation of services is provided, the invocation system being capable of being used by any PAAS and SAAS application built using the general computing abstraction. The invocation system advantageously offers a singular interface for invoking a plurality of PAAS and SAAS applications based on the unique ID assigned to PAAS and SAAS applications.

In a further embodiment in accordance with the present disclosure, a method and system for enabling reusability of PAAS and SAAS applications is provided. The method and system are capable of being used by a PAAS and SAAS application for using PAAS and SAAS applications built by any developer as a dependent application. The method and system beneficially result in rapid development of complex PAAS and SAAS applications.

In yet a further embodiment in accordance with the present disclosure, a method and system for automatic installation of PAAS and SAAS applications on invocation by any PAAS and SAAS application is provided. The method and system effectively eliminate the need for users to install dependencies in advance to installation and use of applications.

In a further embodiment in accordance with the present disclosure, a method and system are provided for efficiently managing dependency problems which may arise when a plurality of PAAS and SAAS services depend on various versions of plurality of other PAAS and SAAS services.

In a further embodiment in accordance with the present disclosure, methods and systems are provided for development and global distribution of applications capable of running on various infrastructure, including but not limited to private data centers and public cloud platforms. The global distribution is efficiently carried out using a repository and marketplace for SAAS and PAAS applications.

In a further embodiment in accordance with the present disclosure, a method and system enabling developers to add authorization to programmed managed services without the need of writing code is provided. The method and system advantageously enable rapid development of PAAS and SAAS by eliminating the need of developing authentication and authorization systems.

In yet a further embodiment in accordance with the present disclosure, a method for launching application instances in one click is provided. The method includes a specification for a text file that is publicly accessible, a system for processing the text file, identifying the user and installing the application in the user's account on a multi-tenant runtime or any runtime the user is authorized to use based on the user's preset preferences, and launching the application instance as per the specification in the text file.

In a further embodiment in accordance with the present disclosure, a method of programming multi-cloud applications is provided where the applications can be deployed on any public cloud or private cloud infrastructures using a runtime.

In a further embodiment in accordance with the present disclosure, a method of programming and delivering open-source applications as PAAS and SAAS applications is provided. The method enables developers to rapidly build PAAS and SAAS applications in any programming language of their choice, test the developed PAAS and SAAS applications on any runtime, and publish the PAAS and SAAS application to PAAS and SAAS application repositories and marketplaces. The developed PAAS and SAAS applications are economically capable of being deployed on self-managed infrastructure or managed multi-tenant platforms.

In a further embodiment in accordance with the present disclosure, a method and system for enabling developers to charge their users for usage of the developed PAAS and SAAS applications in a plurality of ways is provided wherein the charge may or may not include charges for the infrastructure consumption and charges for one or more of a plurality of dependent services.

In a further embodiment in accordance with the present disclosure, a multi-tenant multi-cloud platform is provided. The cloud platform is capable of being used by a plurality of users for installing and using a plurality of SAAS and PAAS applications in parallel. The cloud platform is also capable of installing SAAS and PAAS applications in one or more public cloud platforms, private cloud platforms or private data centers based on user's choice.

In still a further embodiment in accordance with the present disclosure, a method and system for programming autonomous services is provided, the autonomous services requiring little or no manual intervention by the user thereby enabling elimination of DevOps and enabling software engineers to build and deploy applications using autonomous services.

In still a further embodiment in accordance with the present disclosure, a method and system for enabling developers to build hardware agnostic managed services is provided. The method and system enable users to specify runtime specific hardware attributes for configuring managed services at the runtime, where the hardware attributes define the specifics of the hardware resources to be used for the application instances. Non-limiting examples of hardware attributes include volume types (e.g., NVME, SSD, HDD), volume IO, and processor types.

In a further embodiment in accordance with the present disclosure, a self-service portal is provided. The self-service portal is a marketplace and a hub of cloud, platform and infrastructure agnostic PAAS and SAAS applications which is capable of being used by users for discovering, installing, and using PAAS and SAAS applications.

In still a further embodiment in accordance with the present disclosure, a method and system for rapid development of user interfaces for PAAS and SAAS applications is provided which enable users to build user interfaces by declaring user interfaces in an acceptable format like json or xml, thereby empowering developers to create user interfaces without having to learn new front-end technologies.

Desktop applications are generally delivered using a storage medium like CD-ROM, or DVD or via a network like the internet. Users generally install applications by inserting the storage medium into a device capable of reading the storage medium on a computer or by executing the files downloaded onto the computer using the network like the internet.

As desktop applications are generally single tenant, development of desktop applications does not involve complexities associated with development of other technologies like multi-tenant SAAS applications. Most desktop applications, for example a word processor, are designed for optimal performance on one device and for usage by one user at a given time. Desktop applications are generally designed for resource efficiency and/or exploiting all resources available on the computing device the desktop application is designed for. Also, desktop applications are generally not designed for scalability, as happens in the case of PAAS or SAAS applications which are usually designed for scalability.

When translating to a different platform, developers of desktop applications may have to rewrite the applications to run them on the different platform. For example, a spreadsheet application written for Windows may require parts of the code or the entire code base to be re-written in a different programming language to make it run efficiently on Mac. In the case of computer games, for the programming languages such as JAVA, C#, C++, or Action Script, an application developed in one programming language (e.g., Action Script) may have to be ported to another programming language when not supported by a device platform. Moreover, the platform and programming language combination may lack features or functionality required to build an application, thereby making it challenging to achieve application consistency across various platforms.

Lastly, sales and marketing of desktop applications and traditional software has been challenging and global distribution of desktop software is an art mostly practiced by large corporations. Individual developers, small teams and small businesses generally find it very difficult to distribute and sell their software.

A second type of application are those hosted as Platform as a service (PAAS) and Software as a service (SAAS), which are application licensing and delivery models in which applications are centrally hosted on remote servers, are accessible over a network like the internet and are designed to be accessed by a plurality of users at a given time (i.e., PAAS and SAAS are multi-tenant applications). PAAS and SAAS applications are usually licensed on a subscription model.

When compared to desktop applications, PAAS and SAAS applications are relatively more complex to build. For example, building MySQL as a service, depending on the features being built and technologies being used, would require a team of skilled engineers and a significant amount of time to build.

A typical MySQL as a service would require at least a number of systems to be built such as a website with all functionality for users to register and interact with the MySQL service for a plurality of functions including but not limited to launching new MySQL clusters and terminating MySQL clusters. Additional systems would include systems for lifecycle management of MySQL clusters, lifecycle management of MySQL proxy servers, and APIs for the MySQL PAAS service. Further systems would typically include administrative controls for management of the entire service; systems for authentication and authorization; systems for telemetry, usage measurement and billing; systems for automated processing of payments; systems for log collection, storage and archival; and systems for scheduled and ad hoc backups. Further systems could include systems for restoration of databases from backups, systems for point-in-time backup and restore, systems for auto-scaling databases, and systems for providing access to MySQL clusters via network on a multi-tenant system. Additional systems may include systems for data encryption, secrets management, and separation of concerns; systems for fault tolerance and automated recovery from machine failure; systems for MySQL version updates; systems for enabling users to upgrade MySQL clusters; systems for deployment of TLS certificates; and systems for events and notifications. All these systems typically would be built keeping scalability and security in mind, yet building scalable systems is generally complex and requires software engineers skilled in the art of building scalable distributed systems.

Building a scalable SAAS application is generally more complex than building a PAAS application like a MySQL service. For example, building a scalable Wordpress service requires a team of software engineers that are skilled not just in Wordpress but also in databases, search engines, in memory key value databases, http servers, and other technologies as required, depending on the features of the Wordpress service.

To build a scalable and reliable Wordpress service, software engineers have to build systems to manage all dependent applications such as MySQL (Database), Apache SOLR (Search engine), Redis (In memory key value database), and Nginx (http service). For example, to build a Wordpress service that can be used to host a large number of Wordpress websites, software engineers will have to internally build all automations needed to ensure MySQL servers are launched and consumed in the most efficient manner. In most cases, the effort would likely be equivalent to building each of the dependent applications as an independent PAAS service.

Unlike desktop applications, SAAS applications can be updated centrally and the updates would be applicable for all users. Therefore, users are generally not required to update applications themselves and security issues are generally fixed as soon as they are identified.

Deploying and maintaining PAAS and SAAS applications requires deep technical expertise of the platform on which the PAAS and SAAS applications are being deployed. This requirement has resulted in creation of a new art usually referred to as Devops (Development Operations). Software engineers with skills to build an application, generally do not possess the deep technical expertise needed to deploy and maintain the applications. In many cases, it is also a matter of preference: software engineers who build applications generally prefer building applications and are generally not interested in the art of DevOps. It is the software engineers with deep technical knowledge of the platform being used for deploying and running PAAS and SAAS applications that are generally the ones who manage the operations. Desktop applications, in one sense, can be considered as build-and-forget applications, whereas SAAS applications require continuous monitoring to ensure service level agreements are met. In addition, SAAS applications require more manpower to build and operate the applications as compared to equivalent desktop applications. Having separate managing teams that build the software and teams that manage the deployment and operation results in inefficiencies. Eliminating deployment and operations generally results in efficiency gains and cost reductions for organizations, among other benefits.

PAAS applications generally increase the overall productivity of software engineering teams. They automate many functions of development operations and prevent engineers from having to write software which is already built and offered as a service. However, not all applications are available as a service and in many cases the cost of PAAS services is significantly higher than the cost of Infrastructure as a service (IAAS).

PAAS applications are generally offered by public cloud companies as part of their public cloud offering or by companies that build and deploy their PAAS services on public cloud infrastructure. Companies with private data centers orchestrated by systems like OpenStack generally do not have feature-rich PAAS applications. The vast breadth of applications provided by public cloud service providers like AWS are generally extremely hard and capital intensive to recreate in a private cloud. This is one of the several reasons users are moving from private data centers to public cloud.

PAAS applications are generally priced higher as compared to IAAS services. This causes many clients to not use managed services and instead manage applications internally while paying only for infrastructure. While PAAS applications automate many operational activities, they are not autonomous and do not completely eliminate the need of managing PAAS applications. Skilled engineers typically setup, configure, maintain and fine tune PAAS applications on an ongoing basis. Moreover, not all applications are available “as a service”.

There are a number of technical problems associated with PAAS and SAAS applications. It is known in the art of security that all types of resources are hackable and that there is no absolute security. As the data of PAAS and SAAS applications is stored on a service provider's servers and not the end user's servers, a major issue of data security and data locality is created. As security is not absolute and vulnerabilities in the best of the systems have been exploited, many organizations have suffered from data leaks. As data stored using SAAS applications can be sensitive and associated with a great number of parties, any leak of data can have far reaching consequences for a large number of users. Thus, SAAS can be risky and sometimes conflicts with data governance regulations.

PAAS and SAAS applications also limit access to user's data. For example, users cannot access messages that were sent before a specific time on a messaging app if they are on a basic subscription plan. Users also cannot ask for a one-time extract of all the messages under a basic subscription plan. Instead, users will have to subscribe to a plan with a higher cost to be able to access their own data. There is also a concern of a user's data being retained or used for purposes not explicitly authorized by the user. For example, use of emails and content for building AI systems for auto suggest features or use of pictures uploaded by users for building computer vision applications could involve unauthorized use of a user's data.

Companies that build PAAS and SAAS applications are generally re-inventing the wheel. For example, a company that is building a Wordpress service would have to build systems for managing and scaling http servers. Likewise, any other company that is building Drupal as a service would have to build identical systems. This results in longer development time and overall lower productivity.

PAAS and SAAS service providers generally use cloud computing platforms for deploying their applications. PAAS and SAAS service providers face challenges like vendor lock-in due to the current fragmented nature of the cloud.

There are also numerous other problems associated with SAAS and PAAS applications known to persons skilled in the art and the above-discussed problems are just the tip of the iceberg.

Turning from PAAS and SAAS application to mobile applications, mobile applications have significantly impacted the lives of millions of users globally. Mobile applications are the primary means users consume computing on their mobile computing devices. Users are able to use maps to navigate, book taxis, take notes and perform many other actions on their mobile phones and other mobile computing devices using mobile applications and this has improved the quality of life and increased overall productivity.

Mobile applications are typically discovered using marketplaces like the Google Playstore or the Apple App store. This ability to easily discover innovative applications is generally not available for PAAS and SAAS applications.

Mobile applications are relatively simple to develop as compared to building highly scalable and reliable PAAS and SAAS applications. This is because mobile applications are generally single tenant applications and do not have the concerns associated with scalable SAAS applications. Mobile applications also do not have dependencies like those present in the case of SAAS applications. In addition, there are frameworks available that aid mobile application developers in rapidly building applications.

However, mobile applications are constrained by the resources available on a mobile computing device. Developers have to factor battery life, CPU, memory, storage and bandwidth into the development of mobile applications. PAAS and SAAS applications usually have a significantly large amount of resources available on demand.

The concept of on demand scaling for mobile applications is largely absent. Users typically replace their mobile computing devices with a device with better resources. Also, data on mobile computing devices is at risk of being lost due to various factors like physical damage and theft.

Apart from the technology challenges associated with the above-mentioned types of applications, there are other issues. For example, selling software globally to all types of clients like large corporations, mid-sized and small businesses, and individuals is a complex and requires finesse and expertise. It is very difficult for a handful of engineers to build and sell software to many types of clients with many different types of infrastructure setups. Also, global distribution of software is a complex art that is generally practiced by large corporations or very well-funded startups.

Further, there are thousands of open-source applications, however it is almost impossible for most users to use the applications reliably and at scale. For example, Mattermost is an open-source alternative to Slack, yet most companies use Slack instead of free Mattermost as running Mattermost reliably at all times is a very challenging problem to solve.

Millions of developers use and contribute to open source, however there are no solutions known that enable rapid development, easy consumption and global distribution of managed services based on open-source applications.

The embodiments of the present disclosure present a whole new approach for building and consuming applications that can address all the problems highlighted hereinabove and create a new paradigm for development and distribution of software. The new approach for building and consuming applications may have more or less of the following twenty characteristics:
1. The approach is simple for developers to build, distribute and maintain applications.
2. The developed applications are able to run on heterogenous public clouds, platforms, and infrastructures.
3. The developers are able to build applications without having prior knowledge of the hardware, platform, infrastructure, cloud, data centers, fault tolerant zones, network configurations, and similar parameters and requirements of the environment that an application would eventually run on.
4. The developed applications offer all the benefits of desktop, mobile and cloud applications while, at the same time, mitigate issues and security risks associated with developing applications for each of the categories.
5. The approach enables software engineers to develop complex SAAS applications with a plurality of dependencies very quickly.
6. The approach enables software engineers to use their existing skills to build PAAS and SAAS applications without having to learn new programming languages or technologies to build managed services.
7. The approach enables delivery of single tenant applications as PAAS and SAAS applications for heterogenous platforms and infrastructures without the need of re-writing the applications for each platform or infrastructure.
8. The approach enables users to use PAAS and SAAS applications privately on their own cloud accounts, data centers, devices (like laptops), or any private infrastructure.
9. The approach addresses security concerns associated with the use of centrally hosted public PAAS and SAAS applications.
10. The approach offers users an ability to discover and consume SAAS and PAAS applications on their choice of infrastructure and platform with similar ease as they discover and consume mobile applications.
11. The approach enables users to run applications in the cloud without worrying about resource constraints associated with mobile computing devices.
12. The approach enables developers to build and deploy cloud independent, platform independent and device independent applications.
13. The approach enables users to install and use SAAS and PAAS applications on any platform and infrastructure.
14. The approach enables automatic update of PAAS and SAAS applications.
15. The approach enables reusability of PAAS and SAAS applications for faster development of managed services.
16. The approach enables development of autonomous applications, thereby eliminating or reducing the need for DevOps.
17. The approach enables developers to monetize their PAAS and SAAS applications.
18. The approach enables data sovereignty and access to data, at will, and without any restrictions.
19. The approach enables delivery of open-source applications as PAAS and SAAS applications.
20. And the approach enables mobile computing users to use cloud applications that would be user device independent.

Apart from desktop, PAAS & SAAS, and mobile applications mentioned above, there are two other important sources of applications: open-source applications and internal applications.

There are more than 100 million public repositories on Github and more than 200,000 repositories have more than 100 stargazers. There are an extraordinary number of applications available in open source. Generally, there is at least one open-source alternative available for each popular closed source commercial PAAS and SAAS application.

While there are enormous amounts of applications available in the public domain, they are generally very difficult to deploy and maintain. Software engineers usually find it hard to build systems for reliable usage of open-source applications. Non-technical users are unable to make use of open-source applications due to lack of knowledge and skills.

Many public cloud platforms offer open-source applications as a service; however, this has been largely limited to popular applications like MySQL, Apache Kafka, and Apache Spark and this accounts for only a fraction of open-source applications. Moreover, offering open-source applications as a service is a time-intensive and capital-intensive job. A solution that enables individual developers to offer open-source applications as a service does not exists at this point and open-source applications that address non-engineering use cases are generally not offered as a service by public cloud providers.

Open-source applications are generally free to use; therefore, means to facilitate usage of open-source applications would increase adoption of open-source applications and reduce costs significantly. Software engineers should be able to not just build open-source applications, but also offer them as easy to use services. In addition, software engineers should be able to build open-source technologies while being able to generate revenue for themselves. This would enable individuals and small teams to independently contribute and build the open-source ecosystem.

As to internal applications, many organizations develop applications internally. For example, a financial institution may develop an in memory database with low latency reads and writes for algorithmic trading. Internal applications ideally should be available as a service for all users within an organization.

However, organizations that build and manage their own applications face the same problems that companies building PAAS and SAAS applications face. Organizations have also been increasingly using public cloud platforms and have been migrating workloads from their private data centers to public cloud. Organizations in their attempt to reduce dependency on one public cloud provider have been looking at ways of developing and deploying applications in a cloud independent fashion.

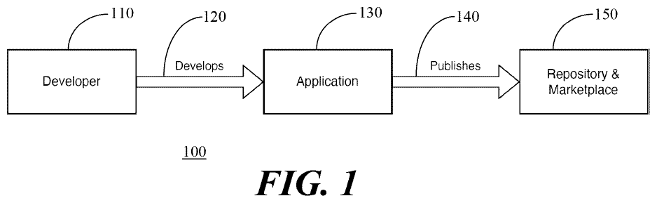

In accordance with an embodiment of the present disclosure, an easy and rapid means of developing and publishing PAAS and SAAS applications is provided. Referring to FIG. 1, an illustration 100 illustrates a high-level application development process in accordance with the present disclosure. A developer 110 develops 120 a PAAS and SAAS application 130 in a programming language of their choice. The developer 110 then publishes 140 the developed application 130 to a SAAS and PAAS application registry and marketplace 150.

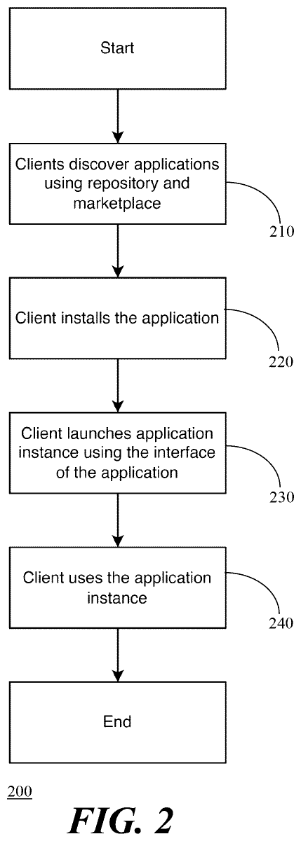

Published applications can be discovered and installed by clients as illustrated in a flowchart 200 in FIG. 2. Clients can discover 210 applications using tools like search. Clients can install 220 an application of their choice and, once the application is installed 220, the client can use the interface of the PAAS and SAAS application to launch 230 one or more application instances. The interface of the PAAS and SAAS service can be an API, UI or any other electronic means. After the application instance has been launched 230, the client uses 240 the application instance. The installation 220 of a PAAS and SAAS application causes an instance of the PAAS and SAAS application to be created. This instance of a PAAS and SAAS application is referred to as application manager. Clients interact with the application manager to launch 230 new instances of the application like a MySQL cluster or a Wordpress site.

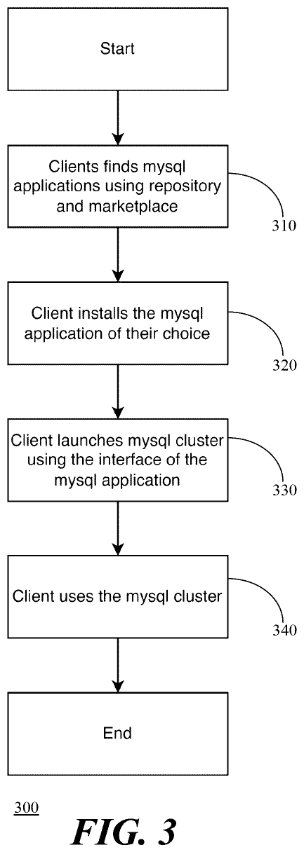

Referring to FIG. 3, a flowchart 300 depicts a first example of a process of a client discovering and using an application. Initially, the client searches for and finds 310 available MySQL applications. The client can choose from available MySQL applications and install 320 an application of their choice. After installation 320 of the MySQL application, the client can use the installed MySQL application to launch 330 one or more MySQL clusters. Finally, the client can use 340 the My SQL cluster.

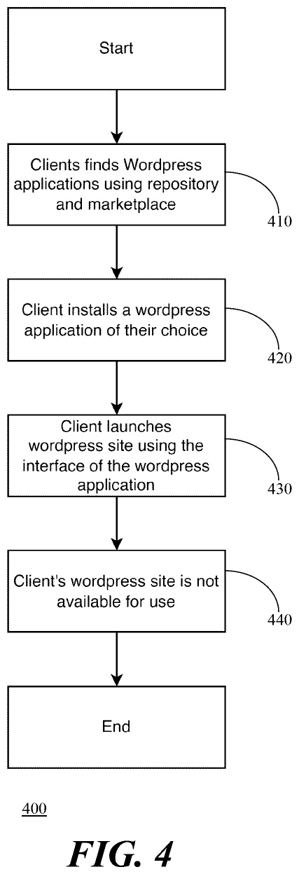

A flowchart 400 in FIG. 4 depicts a second example of a process of a client discovering and using an application. Similar to step 310 in the flowchart 300, the first step involves the client searching for and finding 410 available Wordpress applications using an application repository and/or a marketplace. The client chooses from available Wordpress applications and installs 420 an application of their choice. After installation 420 of the Wordpress application, the client uses the installed Wordpress application to launch 430 one or more Wordpress sites.

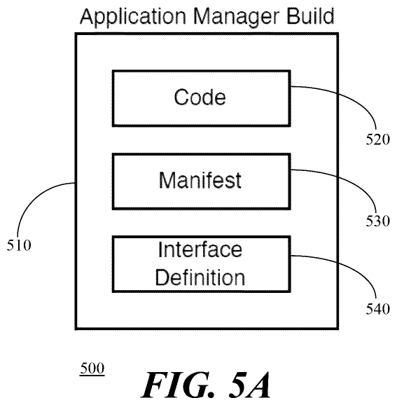

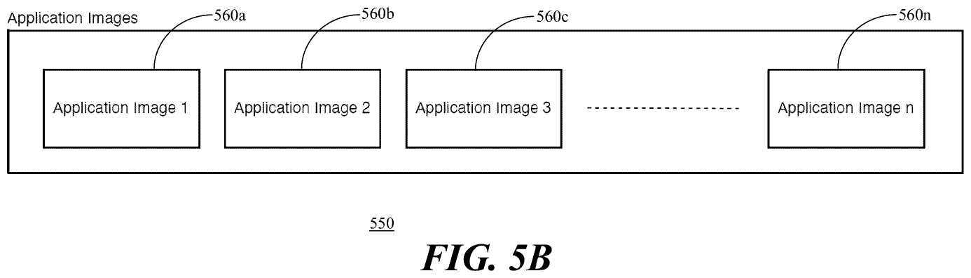

FIGS. 5A and 5B depict illustrations of parts of a typical PAAS and SAAS managed serviced. Referring to FIG. 5A, a block diagram 500 depicts a PAAS or SAAS application manager build and the assets which will be part of the application build which may be pushed to the application repository and marketplace or used for installing the service directly on a runtime. An application manager is an instance of a PAAS or SAAS application with which clients may interact. The instance is processor executable code having the role of an application manager. The application manager is responsible for all management activities of application instances and clients may use an interface exposed by the application manager, in whichever way it may be made available. The application manager uses logical assets provided by the general computing abstraction to create and manage application instances.

The application manager includes application manager code 520. The application manager code 520 may be written in any programming language and should be capable of using the protocol specified by the system implementing general computing abstraction for SAAS or PAAS (hereinafter referred to as ‘runtime’). The application manager code 520 can be an http service, functions or any other means to receive requests from the clients and communicate with the runtime. Optionally, the application manager build 510 may include metadata of the application in a file which may be called a manifest 530. The metadata may contain, but is not limited to, an application name, an application description, or a list of application images. Generally, the application manager defines an interface (i.e., the application manager build includes an interface definition 540) through which the clients, the runtime, or other applications would interact. The protocol that the clients may use to interact with the interface of the application manager may be the same as the protocol implemented by the runtime for its interface. If the application manager code is an http server, the interface definition 540 could be an http API specification. If the application manager code is written to accept invocation from message queues, then the interface definition 540 may be types of messages, the message structure and any other information that would be needed for acceptance, validation and execution of messages. If the application manager code is functions, then the interface definition 540 may be a list of functions with function parameters and return variables specified for each function. Likewise, the application code can implement any other means for interaction with the clients and the runtime and may or may not use the same protocol used by the runtime.

The application being managed by the application manager could be any application capable of execution on a computing device with a processor and a memory. The application may or may not be containerized. Referring to FIG. 5B, a block diagram 550 depicts one or more application images 560 of components or nodes. In case of an application manager managing containerized applications, the application manager may use one or more container images such as the application images 560a to 560n which are container images of various components or nodes that may be required for the application service.

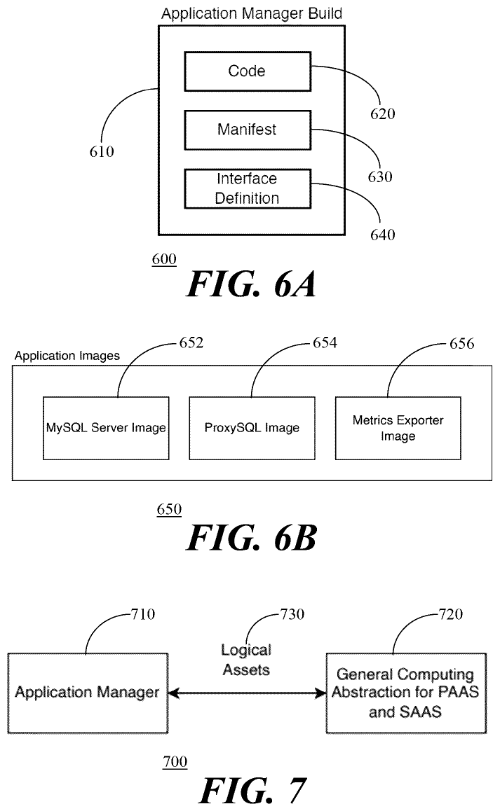

FIGS. 6A and 6B depict an exemplary application build of a MySQL application, showing all the assets of the MySQL application build. Referring to FIG. 6A, a block diagram 600 depicts the MySQL application manager build 610 which contains application manager code 620, a manifest 630 and an interface definition 640. If the application manager is an http service, then the code 620 would be an http server with handlers defined for all the endpoints made available to the clients and the runtime by the application manager. The interface definition 640 would then contain definition of all the endpoints that are to be made available. Referring to FIG. 6B, a block diagram 650 depicts application images that the application manager is using to run the My SQL clusters. A MySQL server image 652 will be used to run My SQL servers, a Proxy SQL image 654 will be used to create ProxySQL nodes, and a metrics exporter image 656 will be used to execute a MySQL metrics exporter. It is possible that the application manager may use means other than using container images if such means are supported by the runtime.

Referring to FIG. 7, a diagram 700 depicts a typical application manager utilizing general computing abstraction for PAAS and SAAS for creation and management of logical assets. An application manager 710 uses an interface defined by the general computing abstraction 720 to orchestrate applications. The interface makes available actions available on the logical entities defined by the generation computing abstraction 720. The application manager 710 uses the interface defined by the general computing abstraction 720 to create and act on logical assets 730 for orchestration of applications. The runtime implements the logical assets by orchestrating physical assets on an infrastructure, cloud platform or any computing devices. The runtime, likewise, may also implement the logical assets 730 by orchestrating further logical assets on a given platform. The interface defined by the general computing abstraction 720 may be APIs which may be invoked using HTTP, RPC, gRPC or any other electronic means. The means used for invoking the interface are defined by the runtime implementation and can include a developer's program infrastructure and platform independent applications by programming applications that use the interface of the general computing abstraction 720.

### General Computing Abstraction

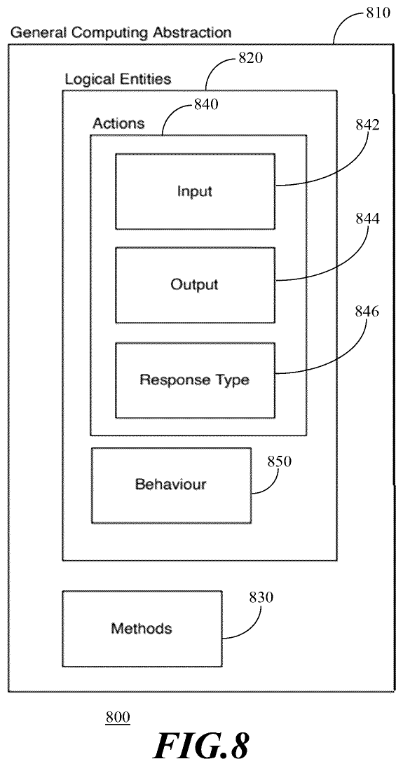

FIG. 8 depicts a diagram 800 of a high-level logical representation of an abstraction for general computing 810 in accordance with the present disclosure. The general computing abstraction 810 has two parts: logical entities 820 (also called logical assets or virtual assets) and methods 830. The general computing abstraction 810 may specify a plurality of logical entities 820 that developers may use to build platform and infrastructure independent applications including but not limited to PAAS and SAAS applications. A runtime implements the logical entities 820 specified by the general computing abstraction 810 for the platform, infrastructure or computing devices the runtime is programmed for. The general computing abstraction 810 may also specify a plurality of methods 830 that specify how certain PAAS and SAAS features would be used by the developers and implemented by the runtimes. The methods 830 may further specify the interface a runtime may provide. A non-limiting example of a method 830 is monitoring where a monitoring method may require a runtime to provide a query interface which may be used by the managed services to query the collected metrics. The monitoring method may further specify how a runtime may implement monitoring. A non-limiting example of a monitoring implementation would be to implement a pull-based system for scraping metrics from metrics exporters.

The logical entities 820 further specify actions 840 and behaviors 850. The actions 840 are actions that clients can initiate on a logical entity 820. For example, if the logical entity is “Secrets”, then a non-limiting example of actions could be create, delete, modify, allow access, and revoke access. The actions 840 further specify an input 842, an output 844 and a response type 846. The input 842 specifies data and constraints for data that should be provided by the client when the action is initiated. For example, for the logical entity “Secrets”, the create action's input may, at the least, be two fields “key” and “value”. Both key and value fields may be further associated with constraints like allowed characters, and length of string. The actions 840 may further specify the output 844 which is structure, content and/or type of data that should be returned by the runtime in one or more scenarios. In addition, the actions 840 may further specify the response type 846. The response type 846 may either be synchronous or asynchronous. A synchronous response type implies that the action will be carried out synchronously and the result of the action may be a response sent over the same connection. An asynchronous response type implies that the request for the action may either be accepted or rejected. If the request for the action is accepted, the action may be carried out by the runtime asynchronously in a non-blocking fashion and a callback to the application manager may be sent once the action is complete. The output 844 may specify data that should be returned by the runtime in response to a synchronous request, and in the payload of the callback request. The output 844 may further specify a range of possible values, codes, descriptions and/or similar information for various scenarios.

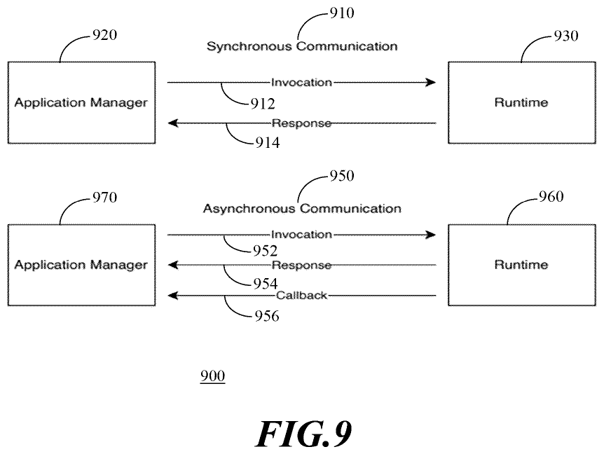

The communication between the application manager and the runtime in accordance with the present disclosure is depicted in an illustration 900 in FIG. 9. Synchronous communication 910 and asynchronous communication 950 are both depicted in the illustration 900. In the synchronous communication 910, a runtime 930 performs the action requested by an application manager 920 immediately upon receiving an invocation 912 and may return a response 914 as the output. In the asynchronous communication 950, a request from an application manager 970 received by a runtime 960 as an invocation 952 may either be accepted or rejected and a response 954 may be sent with the specified output. If the request was accepted, a callback 956 with specified output as payload may be sent to the application manager.

Referring back to FIG. 8, the logical entity 820 may further specify the behavior 850 of the logical entity 820. The behavior 850 may specify a lifecycle of a given logical entity, a relationship of a logical entity instance to other instances of the same or different logical entities, or similar relationships or behaviors. For example, the logical entity “Secrets” specifies what other entities a Secret can be associated with, which entities can access the secret, and the behavior of the entity upon deletion of related entities.

The methods 830 specify, among various other things, how features of a SAAS and PAAS application may be implemented by runtimes and used by application managers. A method 830 may further specify the interface a runtime may implement as part of the implementation of the method 830. Consider a non-limiting example where a method specification may specify details on how identity and access management may work. The method specification may specify how developers can use identity and access management for their PAAS and SAAS applications and how runtimes should handle identity and access management. Further identify and access management methods may specify an interface which could be used by managed services or other entities.

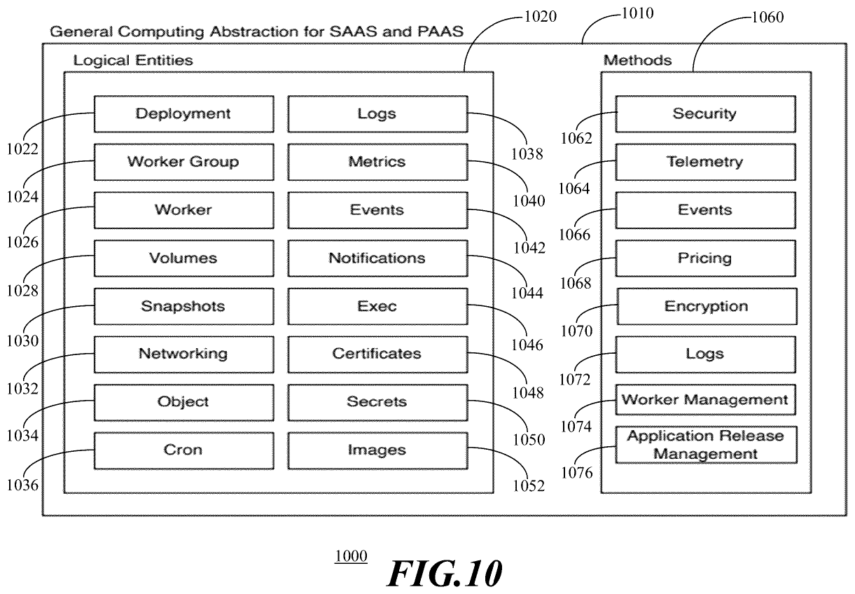

Referring to FIG. 10, a diagram 1000 presents another logical representation of a general computing abstraction for SAAS and PAAS in accordance with the present disclosure. Preferable features of logical entities 1020 and methods 1060 are shown. It is contemplated that the logical entities 1020 and the methods 1060 may have more or less than those shown and still be within the scope of the present disclosure.

Deployment 1022 is a logical entity 1020 that encapsulates the application nodes of a given application instance. For example, clients can launch one or more MySQL clusters using a MySQL application. A given MySQL cluster may be created as a deployment 1022 and all application nodes of the given MySQL cluster may be started under the deployment 1022. Likewise, a Wordpress site launched using a Wordpress application may equate to a deployment 1022. An instance of a deployment 1022 may define its own network. All logical entities 1020 created for an application instance generally are created under a deployment 1022. For example, cron 1036, secrets 1050, worker groups 1024, and workers 1026 are associated with a deployment 1022. A deployment 1022 may be assigned a unique ID which can be used by developers to uniquely identify deployments.

A deployment 1022 may have one or more of the following actions:

Launch: Launch causes creation of a deployment 1022. If the launch request also specified worker groups 1024, the deployment 1022 will be created along with the specified worker groups. A launch action may accept a name of the deployment 1022 and details of one or more worker groups 1024 that will be launched under the new deployment. Creation of a deployment 1022 is an asynchronous operation. If a launch request is accepted, a status code with description is returned with an appropriate status code and description to indicate the acceptance of the request. If a launch request is rejected for any reason a status code with a description is returned with an appropriate status code and description to indicate the rejection of the request. The launch action may optionally accept a token for idempotency. The launch action may further specify output data that will be sent to the invoking application manager as part of the payload of a callback request. Callbacks are invoked on application managers once the process of the executing the action is completed. The output of the launch action may contain a status code, a description and details of the launched deployment if the deployment 1022 was launched successfully.

Terminate: Terminate triggers deletion of a deployment 1022 and all the worker groups 1024, workers 1026 and other logical entities 1020 that were created for the deployment 1022. One or more logical entities such as objects 1034, logs 1038, or snapshots 1030 may not be deleted upon termination of a deployment 1022. Termination of a deployment 1022 is an asynchronous operation. If a terminate request is accepted, a status code with a description is returned with an appropriate status code and description to indicate the acceptance of the request. If a terminate request is rejected for any reason, a status code with a description is returned with an appropriate status code and description to indicate the reason for rejection of the request. A terminate action may optionally accept a token for idempotency. The terminate action may further specify output data that will be sent to the invoking application manager as part of the payload of a callback request. The details of the output data may contain a status code and a description.

Stop: a stop action causes all running workers 1026 in a deployment 1022 to be stopped. Stopping of workers 1026 may result in stopping of virtual machines, termination of containers or both while retaining all the other legal entities like volumes 1028, secrets 1050, cron 1036, or snapshots 1030. Stopping deployment 1022 is an asynchronous operation. If a stop request is accepted, a status code with description is returned with an appropriate status code and a description to indicate the acceptance of the request. If a stop request is rejected for any reason, a status code with a description is returned with an appropriate status code and description to indicate the reason for rejection of the request. A stop action may optionally accept a token for idempotency and a stop action may further specify output data that will be sent to the invoking application manager as part of the payload of a callback request. The details of the output data may contain the status code and the description.

Start: A start action triggers all stopped workers 1026 in a deployment 1022 to be started. Starting of workers 1026 may result in starting of bare metal servers, virtual machines, containers or any combination of bare metal servers, virtual machines and containers. Starting of deployment 1022 is an asynchronous operation. If a start request is accepted, a status code with a description is returned with an appropriate status code and description to indicate the acceptance of the request. If a start request is rejected for any reason, a status code with a description is returned with an appropriate status code and description to indicate the reason for rejection of the request. A start action may optionally accept a token for idempotency. The start action may further specify output data that will be sent to the invoking application manager as part of the payload of a callback request. The details of the output data may contain a status code and a description.

Describe: A describe action returns data containing information of one or more deployments 1022. A describe is a synchronous process and the response to a describe call will contain either details of one or more deployments 1022 if the call was successful or an error code and description if the call was unsuccessful.

The actions of a deployment 1022 and associated input data, output data, behavior are preferable features only. It is contemplated that deployment actions may be more or less of the actions described here and still be within the scope of the present disclosure.

A worker group 1024 is a logical entity 1020 that encapsulates application nodes of the same type. For example, developers can launch one or more MySQL proxy nodes under one worker group 1024. A deployment 1022 can contain one or more worker groups 1024. And a worker group 1024 may be associated with a load balancer to load balance traffic amongst all the workers 1026 of a worker group 1024. For example, a Wordpress site launched using a Wordpress application may use one worker group to launch http servers and another worker group to launch MySQL workers. The load balancer associated with the http server worker group will balance load amongst all http server workers.

A worker group 1024 may be used for scaling up and scaling down the workers 1026 based on any event. A worker group 1024 with load balancer may be associated with an external DNS name, internal DNS name, external IP address, internal IP, SSL certificates, network rules, or similar items. A unique ID may be assigned to a worker group 1024 which may be used by developers to uniquely identify the worker group.

A Worker Group 1024 may have one or more of the following actions:

Launch: A launch action causes a worker group 1024 to be launched under a deployment 1022. A worker group 1024 cannot be created in accordance with the present disclosure without a deployment 1022. A worker group launch action may be associated with input data which may contain a name, a container image, a size of the worker group, or similar worker group parameters. The launch action is an asynchronous operation. If a launch request is accepted, a status code with a description is returned with an appropriate status code and the description to indicate the acceptance of the request. If a launch request is rejected for any reason, a status code with a description is returned with an appropriate status code and the description to indicate the reason for rejection of the request. The launch action may optionally accept a token for idempotency. The launch action may further specify output data that will be sent to the invoking application manager as part of the payload of a callback request. Callbacks are invoked on application managers once the process of executing the action is completed. The output of the launch action may contain a status code, a description and details of the launched worker group 1024 if the worker group 1024 was launched successfully.

Terminate: A terminate action causes a worker group 1024 to be terminated. Termination of a worker group 1024 causes all workers 1026 under the worker group 1024 to be terminated. The terminate action is an asynchronous operation. If a terminate request is accepted, a status code with a description is returned with an appropriate status code and a description to indicate the acceptance of the request. If a terminate request is rejected for any reason, a status code with a description is returned with an appropriate status code and a description to indicate the reason for rejection of the request. The terminate action may optionally accept a token for idempotency. The terminate action may further specify output data that will be sent to the invoking application manager as part of the payload of a callback request. Callbacks are invoked on application managers once the process of executing the action is completed. The output of the terminate action may contain the status code and the description.

Stop: A stop action causes all running workers 1026 in the worker group 1024 to be stopped. Unlike the stop action of deployment 1022, the stop action of a worker group 1024 affects workers 1026 of the worker group 1024 only, whereas stopping a deployment 1022 results in stopping all workers 1026 under all worker groups 1024 of the deployment 1022. The stopping of workers 1026 may result in stopping of bare metal servers, virtual machines or termination of containers while retaining all the other entities such as volumes 1028, secrets 1050, cron 1036, and snapshots 1030. The stop action is an asynchronous operation. If a stop request is accepted, a status code with a description is returned with an appropriate status code and description to indicate the acceptance of the request. If a stop request is rejected for any reason, a status code with a description is returned with an appropriate status code and description to indicate the reason for rejection of the request. The stop action may optionally accept a token for idempotency. The stop action may further specify output data that will be sent to the invoking application manager as part of the payload of a callback request. Callbacks are invoked on application managers once the process of executing the action is completed. The output of the stop action may contain the status code and the description.

Start: A start action triggers all stopped workers 1026 in a worker group 1024 to be started. Unlike the start action of a deployment 1022, the start action of a worker group 1024 affects stopped workers 1026 of the worker group 1024 only. The starting of workers 1026 may result in starting of bare metal servers, virtual machines or containers and the starting of a worker group 1024 is an asynchronous operation. If a start request is rejected for any reason, a status code with a description is returned with an appropriate status code and description to indicate the reason for rejection of the request. A start action may optionally accept a token for idempotency. The start action may further specify output data that will be sent to the invoking application manager as part of the payload of a callback request. Callbacks are invoked on application managers once the process of executing the action is completed. The output of the start action may contain the status code, the description and details of the worker group 1024 and all of its workers 1026.

Mark Healthy: The mark healthy action causes a health status of the worker group 1024 to be set as healthy if it was previously set as unhealthy. The marking of a worker group 1024 as healthy causes the worker group to start receiving traffic. Mark healthy is an asynchronous operation. If a mark healthy request is accepted, a status code with a description is returned with an appropriate status code and description to indicate the acceptance of the request. If a mark healthy request is rejected for any reason, a status code with a description is returned with an appropriate status code and description to indicate the reason for rejection of the request. A mark healthy action may optionally accept a token for idempotency. A mark healthy action may further specify output data that will be sent to the invoking application manager as part of the payload of a callback request. Callbacks are invoked on application managers once the process of executing action is completed. The output of the mark healthy action may contain a status code, a description and details of the worker group 1024 and all of its workers 1026.

Mark Unhealthy: A mark unhealthy action causes the healthy status of the worker group 1024 to be set as unhealthy. An unhealthy status causes the workers 1026 in the worker group 1024 to stop receiving network traffic. A worker group 1024 can be marked unhealthy when it needs to be taken offline for maintenance. Mark unhealthy is an asynchronous operation. If a mark unhealthy request is accepted, a status code with a description is returned with an appropriate status code and description to indicate the acceptance of the request. If a mark unhealthy request is rejected for any reason, a status code with a description is returned with an appropriate status code and a description to indicate the reason for rejection of the request. A mark unhealthy action may optionally accept a token for idempotency. A mark unhealthy action may further specify output data that will be sent to the invoking application manager as part of the payload of a callback request. Callbacks are invoked on application managers once the process of executing the action is completed. The output of the mark unhealthy action may contain a status code and a description.

Update: An update action can be used to update one or more fields of a worker group 1024. For example, an update can be used to update container images, a size of the worker group 1024, or resource limits of workers. The update action is an asynchronous operation. If an update request is accepted, a status code with a description is returned with an appropriate status code and description to indicate the acceptance of the request. If an update request is rejected for any reason, a status code with a description is returned with an appropriate status code and description to indicate the reason for rejection of the request. An update action may optionally accept a token for idempotency. The update action may further specify output data that will be sent to the invoking application manager as part of the payload of a callback request. Callbacks are invoked on application managers once the process of executing the action is completed. The output of the update action may contain a status code, a description and details of the worker group 1024 and all of its workers 1026.

Scale Up: A scale up action is used to add new workers 1026 to a worker group 1024. Developers may use scale up for adding capacity when a load on the workers 1026 increases. The scale up is an asynchronous operation. If a scale up request is accepted, a status code with a description is returned with an appropriate status code and description to indicate the acceptance of the request. If a scale up request is rejected for any reason, a status code with a description is returned with an appropriate status code and description to indicate the reason for rejection of the request. A scale up action may optionally accept a token for idempotency. The scale up action may further specify output data that will be sent to the invoking application manager as part of the payload of a callback request. Callbacks are invoked on application managers once the process of executing the action is completed. The output of the scale up action may contain a status code, a description and details of the worker group 1024 and all of its workers 1026.

Scale Down: A scale down action is used to remove workers 1026 from a worker group 1024. Developers may use scale down for removing capacity when a load on the workers 1026 decreases. A scale down is an asynchronous operation. If a scale down request is accepted, a status code with a description is returned with an appropriate status code and description to indicate the acceptance of the request. If a scale down request is rejected for any reason, a status code with a description is returned with an appropriate status code and description to indicate the reason for rejection of the request. A scale down action may optionally accept a token for idempotency. The scale down action may further specify output data that will be sent to the invoking application manager as part of the payload of a callback request. Callbacks are invoked on application managers once the process of executing the action is completed. The output of the scale down action may contain a status code, a description and details of the worker group 1024 and all of its workers 1026.

The actions of a worker group 1024 and associated input data, output data, and behavior are preferable features only. It is contemplated that worker group actions along with input data, output data, and behavior may be more or less of the actions described here and still be within the scope of the present disclosure.

A worker 1026 is a logical entity 1020 that represents a single application node. For example, a worker 1026 can be a MySQL server, a ProxySQL server, or an http server. Developers can launch one or more workers 1026 to cause launching of servers, virtual machines, or containers on a runtime. A worker 1026 belongs to a worker group 1024 and the worker 1026 may have a name, a DNS address, an IP address, a unique ID to uniquely identify the worker, environment variables, tags, infrastructure preferences like CPU architecture, and a GPU.

A worker 1026 may have one or more of the following actions:

Launch: A launch action causes a worker 1026 to be launched. A worker 1026 belongs to a worker group 1024 and cannot be created without first creating a worker group 1024. A worker launch action may be associated with input data which may contain a name, a container image, environment variables, tags, or similar data. A launch action is an asynchronous operation. If a launch request is accepted, a status code with a description is returned with an appropriate status code and description to indicate the acceptance of the request. If a launch request is rejected for any reason, a status code with a description is returned with an appropriate status code and description to indicate the reason for rejection of the request. A launch action may optionally accept a token for idempotency. The launch action may further specify output data that will be sent to the invoking application manager as part of the payload of a callback request. Callbacks are invoked on application managers once the process of executing the action is completed. The output of the launch action may contain a status code, a description and details of the launched worker 1026 if the worker 1026 was launched successfully.

Terminate: A terminate action causes a worker 1026 to be terminated and removed from the platform and infrastructure. Termination of a worker 1026 may cause deletion of volumes attached to the worker. A terminate action is an asynchronous operation. If a terminate request is accepted, a status code with a description is returned with an appropriate status code and description to indicate the acceptance of the request. If a terminate request is rejected for any reason, a status code with a description is returned with an appropriate status code and description to indicate the reason for rejection of the request. A terminate action may optionally accept a token for idempotency. The terminate action may further specify output data that will be sent to the invoking application manager as part of the payload of a callback request. Callbacks are invoked on application managers once the process of executing the action is completed. The output of the terminate action may contain a status code and a description.

Stop: A stop action causes a running worker 1026 to be stopped. This stop action is personal to the worker 1026 and does not affect any other workers in the worker group 1024. The stopping of a worker 1026 may result in stopping servers, virtual machines or termination of containers while retaining all other entities like volumes 1028, secrets 1050, cron 1036, or snapshots 1030. A stop action is an asynchronous operation. If a stop request is accepted, a status code with a description is returned with an appropriate status code and description to indicate the acceptance of the request. If a stop request is rejected for any reason, a status code with a description is returned with an appropriate status code and description to indicate the reason for rejection of the request. A stop action may optionally accept a token for idempotency. The stop action may further specify output data that will be sent to the invoking application manager as part of the payload of a callback request. Callbacks are invoked on application managers once the process of executing the action is completed. The output of the stop action may contain a status code and a description.

Start: A start action causes a stopped worker 1026 to be started. Starting the worker 1026 may result in starting bare metal servers, virtual machines or containers. Starting a worker 1026 is an asynchronous operation. If a start request is rejected for any reason, a status code with a description is returned with an appropriate status code and description to indicate the reason for rejection of the request. A start action may optionally accept a token for idempotency. The start action may further specify output data that will be sent to the invoking application manager as part of the payload of a callback request. Callbacks are invoked on application managers once the process of executing the action is completed. The output of the start action may contain a status code, a description and details of the worker if it was launched successfully.

Mark Healthy: A mark healthy action causes the health status of a worker 1026 to be set as healthy if it was previously set as unhealthy. Marking a worker 1026 as healthy causes the worker to start receiving traffic. A mark healthy action is an asynchronous operation. If a mark healthy request is accepted, a status code with a description is returned with an appropriate status code and description to indicate the acceptance of the request. If a mark healthy request is rejected for any reason, a status code with a description is returned with an appropriate status code and description to indicate the reason for rejection of the request. A mark healthy action may optionally accept a token for idempotency. The mark healthy action may further specify output data that will be sent to the invoking application manager as part of the payload of a callback request. Callbacks are invoked on application managers once the process of executing the action is completed. The output of the mark healthy action may contain a status code, a description and details of the worker.

Mark Unhealthy: A mark unhealthy action causes the health status of a worker 1026 to be set as unhealthy. This causes the worker 1026 to stop receiving network traffic. A worker 1026 can be marked unhealthy when the worker needs to be taken offline for maintenance. A mark unhealthy action is an asynchronous operation. If a mark unhealthy request is accepted, a status code with a description is returned with an appropriate status code and description to indicate the acceptance of the request. If a mark unhealthy request is rejected for any reason, a status code with a description is returned with an appropriate status code and description to indicate the reason for rejection of the request. A mark unhealthy action may optionally accept a token for idempotency. The mark unhealthy action may further specify output data that will be sent to the invoking application manager as part of the payload of a callback request. Callbacks are invoked on application managers once the process of executing the action is completed. The output of the mark unhealthy action may contain a status code and a description.

Update: An update action can be used to update one or more fields of a worker 1026. For example, an update can be used to update a container image, resource limits or an environment variable. An update is an asynchronous operation. If an update request is accepted, a status code with a description is returned with an appropriate status code and description to indicate the acceptance of the request. If an update request is rejected for any reason, a status code with a description is returned with an appropriate status code and description to indicate the reason for rejection of the request. An update action may optionally accept a token for idempotency. The update action may further specify output data that will be sent to the invoking application manager as part of the payload of a callback request. Callbacks are invoked on application managers once the process of executing the action is completed. The output of the update action may contain a status code, a description and details of the worker.

The actions of a worker 1026 and associated input data, output data and behavior are preferable features only. It is contemplated that worker actions along with input data, output data, and behavior may be more or less of the actions described here and still be within the scope of the present disclosure.

Volumes 1028 is a logical entity 1020 representing data volumes which can be attached to workers 1026. Volumes 1028 can either be shared or dedicated. Dedicated volumes can be attached to one worker only. Shared volumes can be attached to more than one worker and support multi read/write.

Volumes 1028 may be associated with one of more following actions:

Describe: A describe action returns data of a volume 1028 such as size, mount path, ID of worker 1026 attached to the volume, or ID of the volume. A describe action operation is synchronous.

Create: A create action causes a new volume 1028 to be created. A newly created volume is not attached to any worker 1026. The create action can either create a new empty volume or create a volume using a volume snapshot. A create action is an asynchronous operation.

Attach: An attach action causes an available volume 1028 to be attached to a running worker 1026 on a given mount path. An attach action is an asynchronous operation.

Detach: A detach action causes a volume 1028 to be detached from a worker 1026. A detach action is an asynchronous operation.

Delete: A delete action causes an available volume 1028 to be permanently deleted. A delete action is an asynchronous operation.

Copy: A copy operation copies content of a given volume 1028 into one or more new volumes. A copy volume can be used to create multiple copies of data to be attached to different workers 1026 instead of downloading data on each worker. A copy operation is an asynchronous operation.

The actions of volumes 1028 and associated input data, output data, and behavior are preferable features only. It is contemplated that volume actions along with input data, output data, and behavior may be more or less of the actions described here and still be within the scope of the present disclosure.

Snapshots 1030 is a logical entity 1020 representing volume snapshots. Snapshots 1030 can be utilized by developers to implement features like backups. A snapshot 1030 can be restored by creating a new volume using the snapshot. A developer can use a create action of a volume entity to create new volumes 1028 using a snapshot 1030.

Snapshots 1030 may be associated with one or more of the following actions:

Initiate: An initiate action starts the process of taking a snapshot 1030 of a specified volume 1028. A snapshot 1030 is associated with an application and not a deployment 1022, a worker group 1024, a worker 1026 or volumes 1028. Termination of deployments, worker groups, workers or volumes does not result in deletion of snapshots 1030. An initiate action is an asynchronous request.

Describe: A describe action returns information of a given snapshot 1030. A describe action is a synchronous request.

Delete: A delete action causes permanent deletion of a snapshot 1030. The deleted snapshot may not be recoverable. A delete request is an asynchronous operation.

The actions of snapshots 1030 and associated input data, output data, and behavior are preferable features only. It is contemplated that snapshot actions along with input data, output data, and behavior may be more or less of the actions described here and still be within the scope of the present disclosure.

Networking 1032 is a logical entity 1020 representing network and network resources. An application manager, a deployment 1022, a worker group 1024 and workers 1026 can specify their own network rules. For example, a MySQL worker group can set a rule for access on “port 3306” by workers 1026 from all workers in a HTTP worker group. Default networking rules may be created for an application manager, a deployment 1022, a worker group 1024 and workers 1026. Not all entities may be associated with network rules.

Networking 1032 may be associated with one or more of the following actions—

Allocate Static IP: Allocate static IP causes a new static to be allocated. The allocated IP can be used to attach to a worker 1026 or a worker group 1024. Allocate static IP is an asynchronous operation.

Attach Static IP: Attach static IP causes a static IP to be attached to a worker group 1024 or a worker 1026. Static IP can be force attached if the worker group 1024 or the worker 1026 is already assigned a static IP.

Create Rule: A create rule causes a new networking rule to be created. A create rule is a synchronous operation.

Delete Rule: A delete rule causes a specified networking rule to be deleted. A delete rule is a synchronous operation.

Modify Rule: A modify rule causes updating of an existing rule with a new set of rules. A modify rule is a synchronous operation.

Describe Rule: A describe rule returns either a specific rule identified by a rule ID or one or more rules associated with an application manager, a deployment 1022, a worker group 1024 or a worker 1026. A describe rule is a synchronous operation.

The actions of networking 1032 and associated input data, output data, and behavior are preferable features only. It is contemplated that networking actions along with input data, output data, and behavior may be more or less of the actions described here and still be within the scope of the present disclosure.

Object 1034 is a logical entity representing objects stored using an object storage service. Developers can use object 1034 to upload or download objects. Objects may be associated with a worker 1026, a worker group 1024, a deployment 1022 or an application. Deletion of a deployment 1022, a worker group 1024 or a worker 1026 does not cause uploaded objects 1034 to be deleted because objects have to be deleted explicitly.

Objects 1034 may be associated with one or more of the following actions—

Upload: An upload action causes one or more new objects 1034 to be created and a given file or set of files to be uploaded and associated with the created objects. An upload action is an asynchronous operation. All objects 1034 are assigned a unique ID.

List: A list action returns a list of objects 1034 that meet a given criteria. A list action is a synchronous operation.

Download: A download action causes an object 1034 to be downloaded and stored in a given path. Downloading of an object 1034 does not cause its deletion. An object 1034 can be downloaded on the filesystem of any worker 1026 provided the worker has access to the object.

Delete: A delete operation causes an object 1034 to be permanently deleted.

The actions of object 1034 and associated input data, output data, and behavior are preferable features only. It is contemplated that object actions along with input data, output data, and behavior may be more or less of the actions described here and still be within the scope of the present disclosure.

Cron 1036 is a logical entity 1020 representing time-based events. Developers can use Cron 1036 for creation of time-based events to run periodically at fixed times, dates, or intervals. For example, a MySQL application may provide its users a scheduled backup feature where the user can determine a time at which a backup process would be started. A developer of a MySQL application may make use of Cron 1036 to create a time-based event based on a user's input. Cron 1036 will cause an invocation 912, 952 (FIG. 9) by an application manager at the time specified by the Cron 1036. If the application manager is an http server, a Cron 1036 will cause an invocation of an endpoint on the application manager. If the application manager is a function-based application, Cron 1036 would cause execution of a function responsible for handling the time-based event. If the application manager is a message queue-based system, Cron 1036 will cause a message to be pushed in the message queue.

Cron 1036 may be associated with one or more of the following actions—

Create: A create action causes a new time-based event to be registered. A create action may accept a Cron description or specification with a Linux means, a callback means or an invocation means that specifies how and when the occurrence of an event will be communicated to an application. Every Cron event may be assigned a unique ID. A Cron 1036 is associated with a deployment entity instance.

Update: An update action may be used for modifying an existing Cron 1036. An update action can be for modifying the Cron specification or for modifying an invocation mechanism.

List: A list action lists all the Cron jobs

Delete: A delete action causes a given Cron 1036 to be deleted which will cause cessation of delivering all future Cron events.

The actions of Cron and associated input data, output data, and behavior are preferable features only. It is contemplated that Cron actions along with input data, output data, and behavior may be more or less of the actions described here and still be within the scope of the present disclosure.

Logs 1038 is a logical entity 1020 representing logs 1038 generated by workers 1026. Developers may use logs 1038 for log streaming and archival. Archived logs 1038 may be treated as objects 1034. Termination of deployments 1022, worker groups 1024 or workers 1026 does not cause logs 1038 generated by the workers 1026 to be deleted.

Logs 1038 may be associated with one or more of the following actions—

Start: A start action causes log streaming and archival of one or more log files or log sources. The logs 1038 are archived preferably on a more durable storage medium like an object storage service. Log streaming and archival can be started for one or more files or log sources on a specific worker 1026, on all workers of a worker group 1024 or on all workers and worker groups of a deployment 1022. A start action may accept parameters that specify a maximum size of archived log files, a number of archived files to retain, and/or similar information. A start action is an asynchronous process. The process of streaming logs and archival is a continuous process which stops only by a stop action or upon termination of an associated worker 1026.

Stop: A stop action causes log streaming and archival of a given log 1038 to be stopped. Stopping does not cause archived files to be deleted. A stop action is an asynchronous process.

List: A list action lists all the files and log sources which are currently being streamed and archived. A list action is a synchronous process.

The actions of Logs 1038 and associated input data, output data, and behavior are preferable features only. It is contemplated that log actions along with input data, output data, and behavior may be more or less of the actions described here and still be within the scope of the present disclosure.

Metrics 1040 is a logical entity 1020 representing all the metrics data collected using a metrics service. Metrics 1040 is also a method for collection, storage and querying of metrics.

The logical entity metrics 1040 is associated with following action—

Query: A query action may be used to fetch metrics 1040 for a given metric and resource. Resources may include a deployment 1022, a worker group 1024, a worker 1026, a volume 1028, and similar resources. A query action may return aggregated metrics, metrics for a time period or an instant metric.

The actions of Metrics 1040 and associated input data, output data, and behavior are preferable features only. It is contemplated that Metrics 1040 actions along with input data, output data, and behavior may be more or less of the actions described here and still be within the scope of the present disclosure.

Events 1042 is a logical entity 1020 representing observable events. Events 1042 may be one of at least three types. Events may be runtime events that are observed by the runtime; events may be application events which are observed by an application manager; or events can be user-defined events where the users or the developers define custom criteria to define an event. For example, termination of a server, virtual machine or container due to hardware degradation is a runtime event; completion of a backup process could be an application event; and RAM consumption breaching a limit of 4 GB could be a user-defined event. Developers could utilize events for improving reliability, alerting, and features like auto scaling.

Events 1042 may be associated with the following actions:

Create: A create action causes a new event 1042 to be created. Developers can create events 1042 which specify criteria. A positive evaluation of criteria implies that the event has been observed. For example, consider an event which specifies RAM usage of a worker 1026 being more than 4 GB as its criteria. When a worker uses more than 4 GB RAM, the event is observed. A create action is synchronous.

Update: An update action causes a given event 1042 to be updated. Developers may update a name of an event, criteria associated with an event or any other field associated with an event allowed to be updated. An update action is synchronous.

Delete: A delete action causes an event to be permanently deleted and a delete action is a synchronous operation.

List: A list action returns a list of all events 1042 that meet specified criteria. The criteria could be a deployment ID, a name of the event or any other way an event can be expressed.

Subscribe: Creation of an event 1042 causes a placeholder event to be created. An event is monitored only if there is at least one subscription. Developers can use a subscription action to subscribe to receiving a notification whenever the event is observed. A subscription input may at least contain an ID of the event or, if the application manager is an http service, a url of the end point being invoked.

Unsubscribe: An unsubscribe action unsubscribes an application manager from receiving notifications for an event.

The actions of events 1042 and associated input data, output data, and behavior are preferable features only. It is contemplated that event actions along with input data, output data, and behavior may be more or less of the actions described here and still be within the scope of the present disclosure.

Notifications 1044 is a logical entity 1020 which enables developers to broadcast notifications. Notifications 1044 could be broadcast via media such as email, SMS, slack notification, or http invocations.

Notifications 1044 may be associated with the following actions—

Create: A create action causes a new notification template to be created. A create action does not cause broadcast of notifications 1044. A create action is a synchronous process.

Send: A send action causes a broadcast of notification(s) 1044 to specified end points. The end points could be an email ID, a mobile phone number, or a http url.

The actions of Notifications 1044 and associated input data, output data, and behavior are preferable features only. It is contemplated that Notifications actions along with input data, output data, and behavior may be more or less of the actions described here and still be within the scope of the present disclosure.

Exec 1046 is a logical entity 1020 for executing any command on a worker 1026 by the application manager. Developers can utilize Exec 1046 for various reasons including but not limited to configuring workers 1026, triggering processes like backup, or performing recovery actions upon failure.

Exec 1046 may be associated with the following actions:

SyncExecute: A SyncExecute action causes an executable to be executed on a worker 1026 or all workers in a worker group 1024 or all workers in a deployment 1022. A SyncExecute action is a synchronous operation. The output of a SyncExecute action may contain exit code and a log 1038 for a command executed on each worker 1026.

AsyncExecute: An AsyncExecute action causes an executable to be executed on a worker 1026 or all workers in a worker group 1024 or all workers in a deployment 1022. An AsyncExecute action is an asynchronous operation. The output of an AsyncExecute action may contain exit code and a log 1038 for a command executed on each worker 1026. An AsyncExecute action may be preferred over a SyncExecute action for long running commands.

The actions of Exec 1046 and associated input data, output data, and behavior are preferable features only. It is contemplated that Exec actions along with input data, output data, and behavior may be more or less of the actions described here and still be within the scope of the present disclosure.

Certificates 1048 is a logical entity 1020 for cryptographic certificates. Developers can use certificates 1048 to issue, renew, deploy, or similar actions.

Certificates 1048 may be associated with the following actions—

Issue: An issue action causes a new certificate 1048 to be issued. The issued certificate can be self-signed or validated by a central authority. Issuing of a certificate does not result in its deployment.

Renew: A renew action causes a certificate 1048 to be renewed. Renewals result in extending the certificate expiry date or issuing a new certificate with a future expiration date.

Deploy: A deploy action causes a certificate 1048 to be deployed to a given path of a worker 1026, all workers of a worker group 1024 or all workers of a deployment 1022.

The actions of Certificates 1048 and associated input data, output data, and behavior are preferable features only. It is contemplated that Certificates actions along with input data, output data, and behavior may be more or less of the actions described here and still be within the scope of the present disclosure.

Secrets 1050 is a logical entity 1020 for securely storing data which may be allowed to be accessed only by a specific worker 1026, a specific set of workers, a specific worker group 1024, a specific set of worker groups or all workers in a deployment 1022. A developer may use secrets 1050 for storing root credentials of a MySQL cluster which can be accessed by MySQL server nodes only. Secrets 1050 may not be accessed outside of a deployment 1022 and are associated with the deployment 1050.

Secrets 1050 may be associated with the following actions—

Store: A store action causes a secret 1050 identifiable by a key to be stored using the secret store service. Developers may specify what entities can access the secret 1050. For example, a MySQL application manager can store MySQL credentials to be used for telemetry and make it accessible only to workers of a MySQL metrics exporter worker group.

Retrieve: A retrieve action causes a secret 1050 to be returned to the requesting entity provided the requesting entity has access to the secret.

Delete: A delete action causes a secret 1050 to be permanently deleted. Any retrieve action after a deletion action will result in an error.

The actions of secrets 1050 and associated input data, output data, and behavior are preferable features only. It is contemplated that Secrets actions along with input data, output data, and behavior may be more or less of the actions described here and still be within the scope of the present disclosure.

Images 1052 is a logical entity 1020 which developers can use to build, store and use container images.

Images 1052 may be associated with the following actions—

Build: A build action builds an image 1052 using an image file. A build action may also pull an image from a public or private repository. Pulling an image from a public or private repository makes an image 1052 available in the runtime for launching workers 1026. A build action stores the built image on a container image repository accessible and used by the runtime. A build action is an asynchronous process.

Delete: A delete action may cause permanent deletion of an image 1052.

The actions of images 1052 and associated input data, output data, and behavior are preferable features only. It is contemplated that Images actions along with input data, output data, and behavior may be more or less of the actions described here and still be within the scope of the present disclosure.

Methods 1060 specify methods required for building SAAS and PAAS applications which may be implemented by the runtimes and used by the application managers.

Security 1062 is a method for enabling identity and access management (IAM) for applications in a way that does not require a developer to write any code. Codeless system for enabling authentication and authorization for managed services is described hereinbelow. A security method requires an application manager to define resources and actions, and to associate such resources and actions with an interface. For example, if a MySQL managed service is written as an http server, a cluster could be a resource with launch as an action. The resource “cluster” and the action “launch” are associated with the http endpoint responsible for handling the launch action of the cluster resource. Similarly, a delete action on a cluster resource is associated with an http endpoint responsible for handling the delete action on the cluster resource. Developers may add mapping of all resources and actions to an interface to manifest a file.

A runtime may parse a manifest to identify all the resources and actions associated therewith and to make the manifest available to runtime administrators to create roles and grant permissions to users as per their business needs. The runtime may further enforce permissions set by the administrators by controlling access to the interface. For example, a user with permission to launch new clusters will be able to invoke an end point for launching new clusters. A user not authorized to launch new clusters will not be able to invoke the end point for launching new clusters.

Thus, the security 1062 method dictates how a developer can offer IAM to its users without writing any code for it. The security 1062 method further requires runtimes to implement IAM to enable developers to leverage a no code solution.

Telemetry 1064 is a method that requires developers to provide a metrics exporter for their applications and for runtimes to collect metrics from exporters for querying and long-term storage.

Events 1066 is a method that has predefined events that a runtime may support and a mechanism for applications to declare application events. The method requires developers to provide details of the events in a manifest file and requires runtimes to parse the manifest and make the events available for subscription. The events 1066 method further requires runtimes to provide an interface for applications to notify an occurrence of an event.

Pricing 1068 is a method that enables developers to charge their users in accordance with arbitrary metrics. For example, a MySQL developer can charge its users on number of rows in the MySQL cluster and another MySQL developer can charge its users on the storage size of the clusters. The pricing 1068 method enables users to declare criteria and price, and does not require users to write code to measure usage and charge users. The pricing 1068 method requires runtimes to implement a system for measuring usage and charging the users. The pricing 1068 method and systems for enabling developers to charge developers on plurality of ways is described hereinbelow.

Encryption 1070 is a method that specifies implementation of an encryption service which developers can use to easily encrypt and decrypt sensitive data without having to build elaborate systems to key rotation and management. Developers are not required to manage encryption and decryption keys themselves as the encryption service should be able to encrypt a file or content and store encryption key(s) securely by using secrets 1050. The encrypted content can be tagged with a unique identifier which can later be used to identify the encryption key used to encrypt the content.

Logs 1072 is a method that specifies how a runtime should provide log streaming and archival service to developers. The logs 1072 method standardizes logging for consistency across all runtimes.

Worker Management 1074 is a method that specifies how a runtime should handle failures like sudden application crashes and hardware degradations. Using a standard worker management 1074 method ensures consistent behavior of workers 1026 across all runtimes.

Application Release Management 1076 is a method that specifies how a runtime should detect availability of updates to an application and then cause update of the application. This ensures consistent behavior across runtimes.

A system implementing logical entities 1020 and methods 1060 specified by the general computing abstraction 1010 is called a runtime. A runtime can be developed for any cloud platform, orchestrator platforms, computing devices, infrastructures, or similar devices or systems. A runtime may implement the entirety of general computing abstraction; doing so makes the runtime capable of running any application built using the logical entities 1020 and behaviors defined by the general computing abstraction 1010. A runtime can be a single tenant system or a multi-tenant system.

FIG. 11 depicts a diagram of a high-level overview of a runtime 1110 implementing 1115 a general computing abstraction 1120, such as the general computing abstraction 1010 (FIG. 10) in accordance with the present disclosure. The runtime 1110 also orchestrates 1125 all the logical assets on a specific platform or infrastructure 1130.

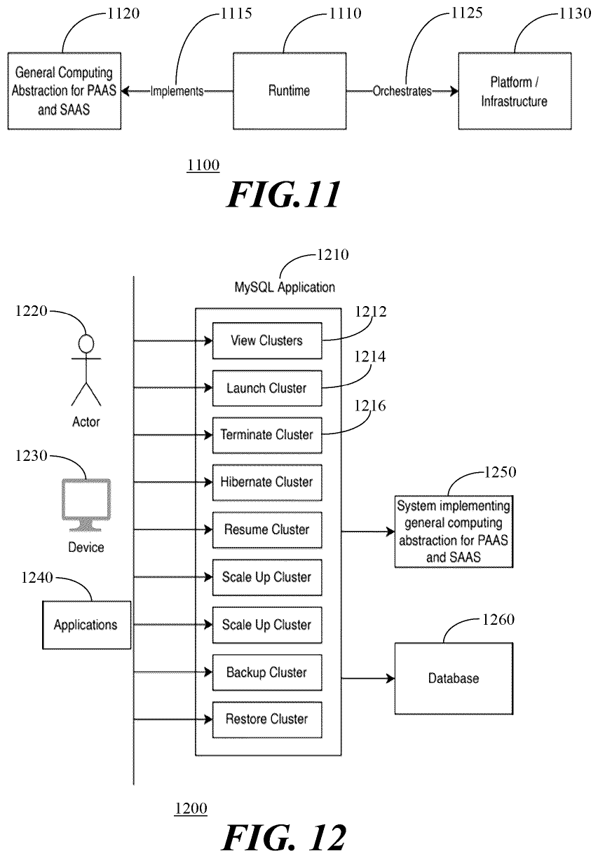

FIG. 12 depicts a diagram 1200 illustrating a MySQL service 1210 utilizing a system implementing general computing abstraction for PAAS and SAAS 1250 (also called a runtime 1250) and a database 1260 in accordance with the present disclosure. The database 1260 may or may not be orchestrated by the runtime 1250 and is an optional component described for the sake of completeness. A MySQL service 1210 installed on a runtime 1250 makes use of the interface exposed by the runtime 1250 to take action on logical entities specified by the general computing abstraction. The MySQL service 1210 may expose one or more interfaces for any of the exemplary actions shown in the diagram 1200 (such as View Clusters 1212, Launch Cluster 1214 or Terminate Cluster 1216) or any similar action. The interface of the MySQL service 1210 may be accessed by one or more clients shown at 1220, 1230 and 1240. The authentication and authorization of the clients 1220, 1230, 1240 may be managed by the runtime 1250.

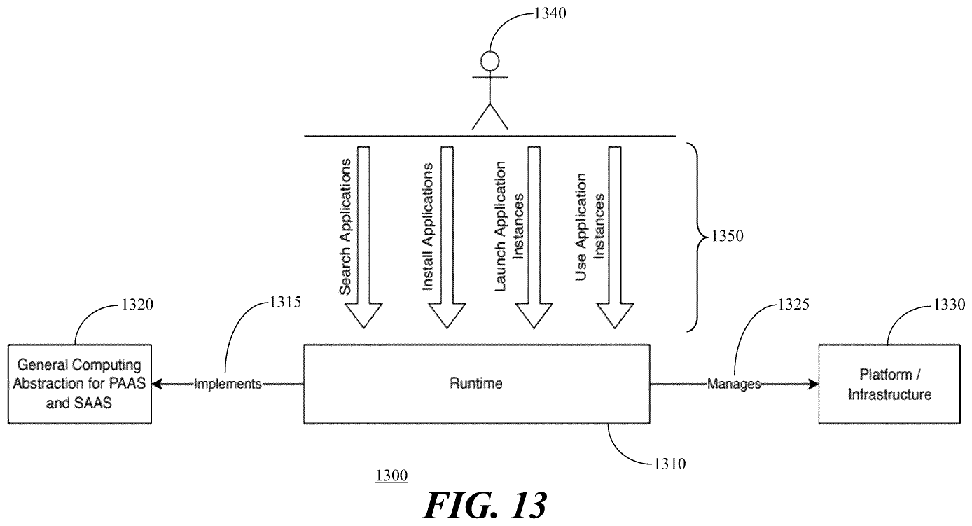

FIG. 13 shows a diagram 1300 of a high-level overview of a runtime 1310 in accordance with the present disclosure. The runtime 1310 implements 1315 a general computing abstraction 1320. The runtime 1310 is built for orchestrating logical entities and managing 1325 methods of the general computing abstraction 1320 on a given platform or infrastructure 1330. Non limiting examples of platforms and infrastructures 1330 include AWS Public Cloud Platform, Kubernetes Container Orchestration Platform, VMWare VSphere datacenter management software, Openstack datacentre management software, one or more Linux devices, and one or more windows devices. A client 1340 may use an interface 1350 made available by the runtime 1310. The interface 1350 provides the client 1340 an ability to search and find applications, develop and install applications, and launch and use application instances. These abilities are non-limiting examples and the runtime 1310 may provide many other capabilities to the client 1340 and other users to use and administer the runtime 1310.

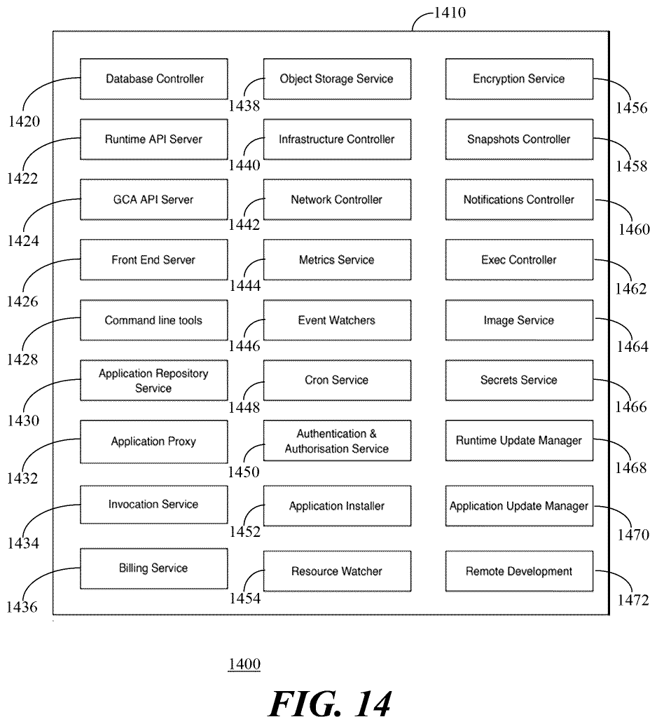

FIG. 14 depicts a logical representation 1400 of a runtime 1410 and its components in accordance with the present disclosure. The runtime 1410 is implementing general computing abstraction.

A database controller 1420 is a service that is responsible for creating and managing a database for the runtime and for managed applications. Each application manager may be provided with a separate database or a separate database server for storage of application manager data. The database controller 1420 may cause creation of database clusters and databases in any number of ways.

A runtime API server 1422 exposes endpoints for interaction with runtime functionalities over HTTP. Instead of HTTP, runtime functionality can be exposed to users by many other means and protocols. Non-limiting examples of runtime functionalities include Identity and Access Management to manage functions like user management and access control, networking to control network access to resources and network access of resources running in the runtime, and certificates service to create or upload public SSL certificates. All capabilities provided by a runtime for managing and administering the runtime may be done via the runtime API server 1422.

A GCA API server 1424 is a service exposing the interface to take actions on logical entities defined by the General Computing Abstraction (GCA). The interface is made available for application managers. The GCA API server 1424 may provide an interface over HTTP or any other electronic means or protocols. Application managers invoke the GCA API server 1424 to take action on logical entities specified by the General Computing Abstraction.

A front end server 1426 is a user interface for all end points of runtime API server 1422. The front end server 1426 may also contain user interfaces for application managers.

The runtime 1410 may also provide its users with command line tools or utilities 1428. Command line utilities 1428 can be used by developers for building, testing and deploying private applications using a runtime before publishing the runtime to a repository and marketplace.

An application repository service 1430 is an interface between the clients and the repository and marketplace of applications built using a General Computing Abstraction. The application repository service 1430 may support users with the ability to search applications, upload applications to the repository, and similar application-related abilities.

An application proxy 1432 routes requests from clients to appropriate application instances by inspecting application identifiers in the payload. The application proxy 1432 is useful when application instances are not provided with network access to receive requests from outside of the runtime environment.

An invocation service 1434 may be used by one or more runtime components to invoke http endpoints of a given application manager. For example, a Cron service 1448 may use an invocation service 1434 to cause invocation of an http endpoint when a time-based event occurs. The invocation service 1434 may use a database to know all the application instances running in the runtime and their DNS names.

A billing service 1436 monitors usage of all applications and generates reports and invoices. The billing service 1436 identifies metrics to be used for billing using the application manifest file.

An object storage service 1438 stores objects in a distributed storage system or any other system that may be used to store, retrieve, or delete objects. Clients can cause storage of objects in an object storage service 1438 by invoicing object store end points via the GCA API Service 1424. The GAC API Service 1424 will then cause the object store service 1438, which may be running as an independent component or bundled as part of a worker, to register and upload objects to the object storage service 1438.

An infrastructure controller 1440 is the interface between the platform and the infrastructure on which the runtime is deployed. The infrastructure controller 1440 causes creation of physical entities for logical entities like worker groups, workers, volumes, and snapshots. The infrastructure controller 1440 may also cause creation of logical entities on certain platforms. Creation of a worker group may cause the infrastructure controller 1440 to create load balancers; configure networking rules; launch new servers, virtual machines or containers; or create volumes. The infrastructure controller 1440 may also cause creation of new virtual machines if the runtime is running a public or private cloud. The infrastructure controller 1440 may further cause creation of containers if the runtime is running on a container orchestration platform like Kubernetes.

A network controller 1442 controls the networking resources and networking rules of the runtime 1410. The network controller 1442 manages the assignment of IP addresses, assignment of DNS names, creating/modifying/deleting of networking rules, and similar tasks. The network controller 1442 may further be associated with components which would create networks and regulate them as per the rules created by users. The runtimes may use network primitives available on either a given platform, infrastructure, or device.

A metrics service 1444 manages the process of collection, storage and querying of metrics. A metrics interface, which is part of the GCA API Server 1424 uses the metrics service 1444 for querying of metrics data. The metrics service 1444 may also specify data retention policies and scaling policies. A metrics querying interface may be used by application managers for providing features like scaling or simple reporting.

Event watchers 1446 periodically evaluate criteria of all events with at least one subscription. The event watchers 1446 will cause broadcast of notifications if an event has been observed. The events may be used by the application managers for enabling features like auto scaling, alerting, and crash recovery.

The Cron service 1448 evaluates all time-based events and triggers invocation of end points whenever a time-based event occurs. Application managers may use the Cron service 1448 for implementing features like scheduled backups. Application managers may also use logical entities for any creative purposes and the examples mentioned here are only for the sake of explanation.

An authentication and authorization service 1450 manages authentication and authorization for all users and enforces policies set by runtime administration using Identity and Access Management. System and methods for codeless implementation of authentication and authorization systems is described further hereinbelow.

An application installer 1452 interfaces with the runtime API servers 1422 and causes deployment of application managers upon receiving a request from a user.

A resource watcher 1454 continuously monitors all resources in the runtime 1410 and causes corrective action if any adverse event is observed. For example, if a virtual machine running a worker fails, the resource watcher 1454 detects the failure and would cause launching of another virtual machine as a replacement.

An encryption service 1456 implements the encryption method specified by the general computing abstraction. The method may require implementation of features like secure storage of encryption keys, authorization mechanism, or similar security features.

A snapshot controller 1458 manages the lifecycle of snapshots. The snapshot controller 1458 interfaces with the underlying platform and infrastructure to snapshot volumes in as efficient a manner as possible.

A notifications controller 1460 manages broadcasting of notifications to multiple end points including but not limited to email, SMS, slack messages, and http invocations. The GCA API Server 1424 uses the notifications controller 1460 to send notifications when requested by application managers.

An exec controller 1462 causes arbitrary commands to be executed on one or more workers. The commands can be executed synchronously or asynchronously. The exec controller 1462 interfaces with the GCA API Server 1424 and application managers can request for execution of commands using the GCA API Server 1424. The exec controller 1462 is a Remote Command Execution logical entity which may be associated with actions like executing an executable on a worker or a set of workers.

An image service 1464 is the implementation of the images logical entity specified by the GCA. An Interface to Image service for application managers is provided via the GCA API Server 1424. The image service 1464 implements the image build process by using tools like Docker and Kaniko. The image service 1464 may also implement and interface with a container image repository.

A secrets service 1466 manages the secure storage of secrets by implementing its own system or by using a service provider. The secrets service 1466 manages the access to secrets to ensure there is no unauthorized access of secrets. The GCA API Server 1424 interfaces with the secrets service 1466.

A runtime update manager 1468 manages updates to the runtime 1410 and its components. The runtime update manager 1468 watches runtime releases and makes the updates available to runtime administrators for installation.

An application update manager 1470 manages updates to installed applications. The application update manager 1470 interfaces with an application repository and storefront to identify applications with updates. The application update manager 1470 also causes presentation of options to users with permissions to install available updates.

A remote development 1472 enables developers to build and run application managers on their local devices while causing creation of logical entities on a remote runtime.

All the components of the runtime 1410 shown in FIG. 14 can be run and orchestrated in a plurality of ways and a person having ordinary skill in the art is well able to accomplish such various runs and orchestrations of the runtime 1410.

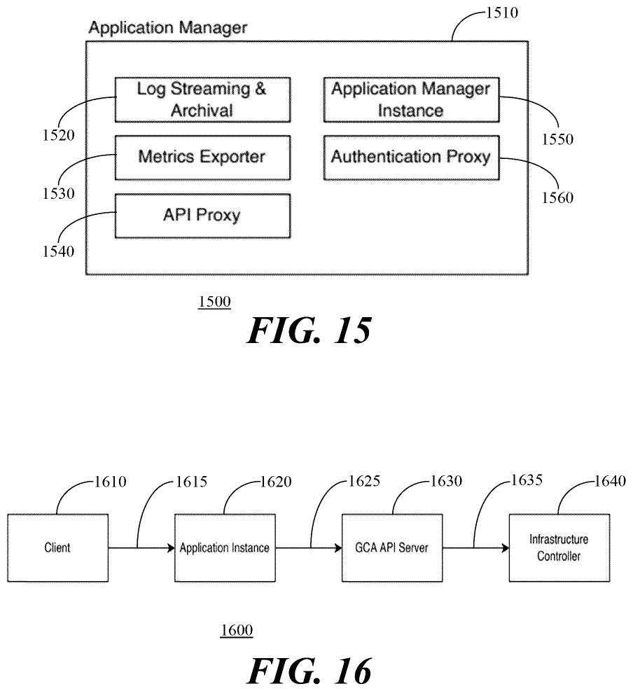

Referring to FIG. 15, a diagram 1500 illustrates logical a representation of an application manager 1510 in accordance with the present disclosure. The application manager 1510 contains components for streaming and archival of application manager logs 1520. A metrics exporter 1530 exports all metrics of the application manager 1510 to measure performance and usage of the application manager 1510. The metrics exporter 1530 may comply with the method for metrics specified by the General Computing Abstraction. An API proxy 1530 may be used as an http interface. If the application manager code is not an http server and implements other means like functions, the API proxy 1530 may be used for invocation of the functions. An application manager instance 1550 is the instance of the application manager code provided by the developer. If the application manager is an http server, the application manager instance 1550 will be an http server. An authentication proxy 1560 implements authorization checks for all application managers.

FIG. 16 depicts a diagram 1600 of an exemplary use of the GCA API Server 1424 (FIG. 14) in accordance with the present disclosure. The client 1610 sends a request 1615 to an application instance 1620. The application instance 1620 may invoke 1625 the GCA API Server 1630 to fulfil request of the client 1610. The GCA API Server 1630 may request 1635 an infrastructure controller 1640 which will cause an action to occur on the underlying platform and the infrastructure. For example, a client 1610 may request 1615 launching a new MySQL cluster to a MySQL application instance 1620. The MySQL application instance 1620 may choose to create a Worker for a new MySQL server, thus the MySQL application instance 1620 may request 1625 the GCA API Server 1630 to launch a new worker. The GCA API Server 1630 will then cause 1635 the infrastructure controller 1640 to launch a new worker. The infrastructure controller 1640 may launch a new bare metal server, a virtual machine or a container or any another manifestation of the process running a MySQL server.

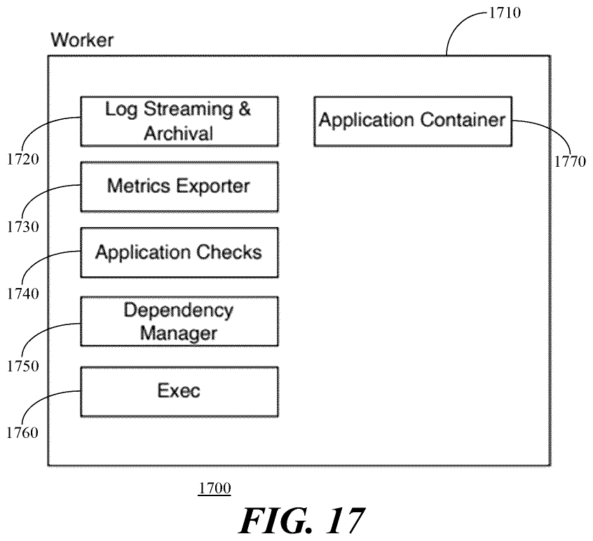

FIG. 17 depicts a logical representation 1700 of a worker 1710 orchestrated by the infrastructure controller 1440 (FIG. 14) in accordance with the present disclosure. The worker 1710 may have one or more components orchestrated as containers, processors or any another means as determined by a runtime. A first component is a log streaming and archival process 1720. A metrics exporter 1730 exports application usage and performance metrics. One or more application checks 1740 may be provided by the developer and a dependency manager 1750 ensures all required software dependencies are available on the worker 1710. An Exec 1760 executes the Exec requests received from the Exec controller 1462 (FIG. 14). An application container 1770 is the main application node that is running the application container. As mentioned earlier, a runtime may cause running of an application node as a container, a process, a micro virtual machine, or any another means as required to implement the general computing abstraction.

### Managed Services Repository and Marketplace

Mobile applications are usually discovered by its users using marketplaces like the Google Playstore or the Apple App store. However, such large and diverse marketplaces are not available for PAAS and SAAS applications. There are many solutions that claim to be a marketplace for PAAS and SAAS applications, however they could at best be considered as a listing of PAAS and SAAS applications. Disclosed hereinbelow are methods and systems for an online repository and marketplace of private or public, infrastructure agnostic, cloud agnostic, platform agnostic, device agnostic, PAAS and SAAS applications.

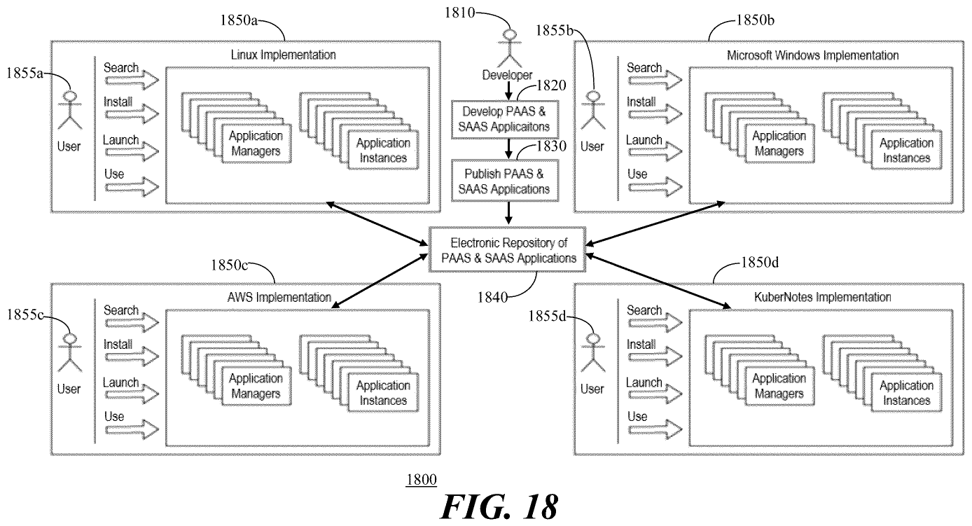

FIG. 18 depicts a high-level illustration 1800 of the development process, electronic repositories and their use by one or more runtimes in accordance with the present disclosure. The development process includes a develop, publish and consume cycle for PAAS and SAAS applications as depicted in the illustration 1800. A developer 1810 develops a SAAS and PAAS application 1820 and subsequently publishes the application 1830 to an electronic repository 1840 where independent runtimes 1850a, 1850b, 1850c, 1850d are designed to orchestrate PAAS and SAAS applications. The runtimes 1850a, 1850b, 1850c, 1850d are capable of communicating with electronic repositories to search, describe and download applications. The runtimes 1850a, 1850b, 1850c, 1850d are also capable of installing applications from information and content obtained from the electronic repository. Users 1855a, 1855b, 1855c, 1855d interfacing with the runtimes 1850a, 1850b, 1850c, 1850d can search and install applications, and launch and use application instances.

Developers can publish applications to an electronic registry by providing application manager code, optionally providing a manifest file, optionally providing interface definitions and optionally providing application images. It is conceivable that an electronic registry can accept any or all of the code, manifest, and interface definitions in any manner. The constituents of an exemplary application build 510 being published to the electronic repository are shown in the block diagram 500, 550 (FIGS. 5A and 5B). It is contemplated that the application manager build 510 may have more or less elements than those shown in the diagrams 500, 550. Developers may upload the application build to the electronic repository or optionally provide a link to the git repository containing the application build. Published applications may either be private or public. Private applications may be accessed only by authorized users whereas public applications would be publicly available to install and use. Applications may either be open-source applications or closed source applications. Code of open-source applications may be available in the public domain. Some applications may require users to pay for usage of software.

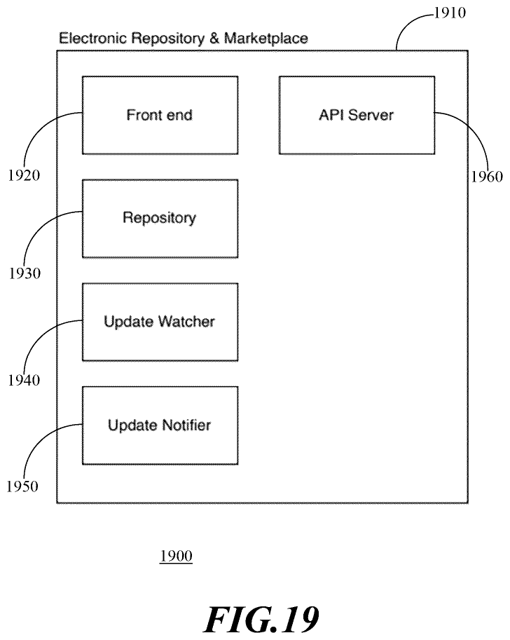

FIG. 19 depicts a logical representation 1900 of an electronic repository and marketplace 1910. The marketplace 1910 broadly constitutes a front end 1920, a repository 1930, an update watcher 1940 and an update notifier 1950. The front end 1920 provides a GUI to clients of the electronic repository for publishing applications, searching applications, installing applications, and similar operations. The repository 1930 is an electronic database of all the applications published on the repository. The update watcher 1940 watches all git-based applications checking for updates. The update notifier 1950 broadcasts availability of updates to all subscribing runtimes. An API server 1960 exposes APIs that clients may use to interface with the electronic repository and marketplace 1910. The marketplace 1910 may contain more or less components than the components described.

In accordance with the present disclosure, a globally unique ID is assigned to the published managed services. The ID is capable of being used for various purposes including but not limited to the purposes described hereinbelow. A person having ordinary skill in the art would know and understand how a unique ID of PAAS and SAAS services could be used.

In one embodiment, the present disclosure provides a method and system for deploying managed services in single click on a plurality of platforms and infrastructures, and optionally launching an application instance of the managed service, the managed services being developed using the general computing abstraction. The managed service provides an ability to launch an application instance and the platforms and infrastructures have a runtime implementing the general computing abstraction and capable of being used by the managed services developed using the general computing abstraction.

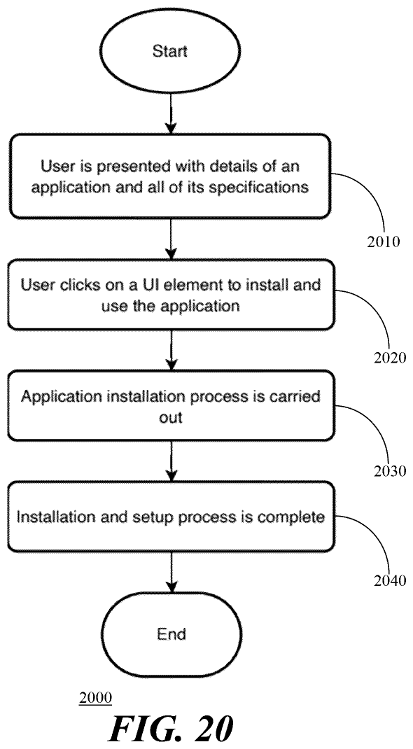

FIG. 20 depicts a flowchart 2000 of the process of launching an application instance in one click in accordance with the present disclosure. Initially, a user is presented 2010 with a web page, a mobile app user interface (UI), or any other electronic information which contains details of an application and specification of the application. The user clicks 2020 a UI element with the intent to install and start using a SAAS or a PAAS application. Application installation process is carried out at step 2030 and the installation process may be carried out on any compatible runtime or a multi-cloud, multi-tenant platform. At step 2040, the application installation process is complete and the user will be able to use their application.

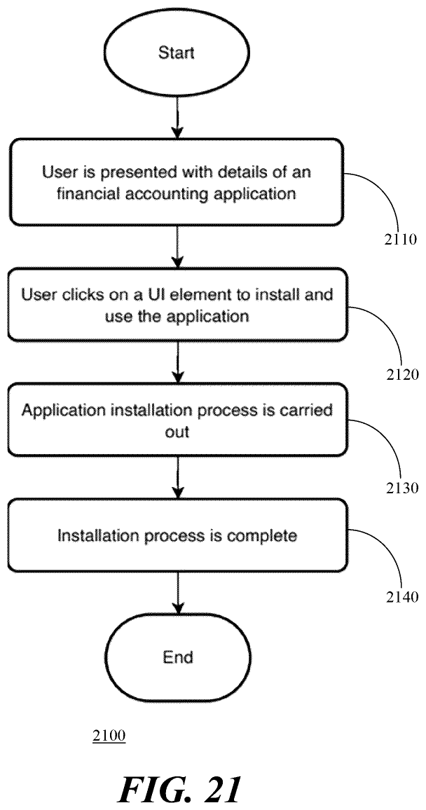

FIG. 21 depicts a flowchart 2100 of an example of the process of launching an application instance in one click in accordance with the present disclosure. A user is presented 2110 information via electronic means about a financial accounting application. The user clicks 2120 on a UI element to install and use the application and the financial accounting application is installed 2130. Once the application is installed 2130, an application instance of the accounting application will be launched. At step 2140, the installation of the accounting application and launch of the accounting application instance is complete. If the installed application is a web service, the user can now start using the application via a web browser.

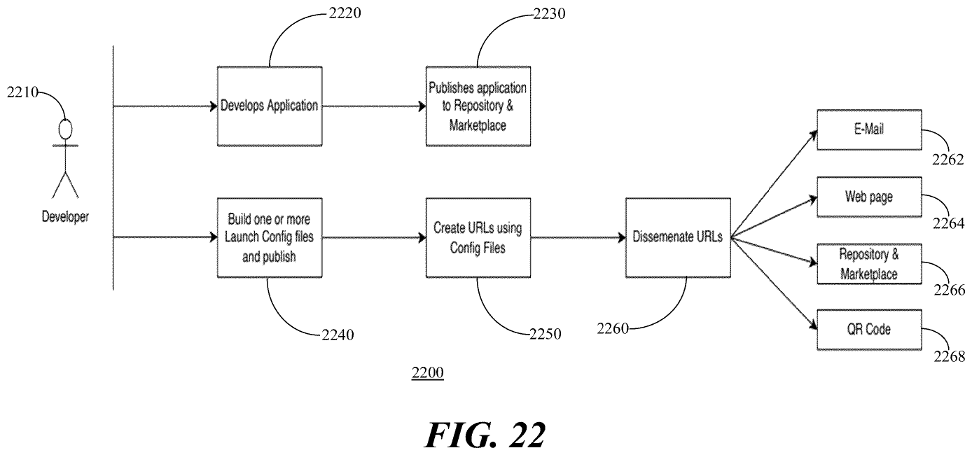

FIG. 22 depicts a diagram 2200 of an example of a developer 2210 building one click launch URLs in accordance with the present disclosure for an application developed by the user. The developer 2210 develops 2220 a managed service and publishes 2230 the managed service to a managed service repository and marketplace. The developer 2210 also builds 2240 one or more launch configuration files and makes them available over a network like the internet. Launch configuration files can be built by any user for a plurality of applications. The launch configuration files may also be auto generated by a computer implemented method. The developer 2210 uses the generated launch config files to create 2250 unique URLs. The developer 2210 may then disseminate 2260 the generated URLs via any electronic means such as via email 2262, via a webpage 2264, via a repository and marketplace 2266, or via a QR code 2268. The electronic dissemination means 2262, 2264, 2266, 2268 are non-limiting examples of means for dissemination of the URLs. A plurality of users may invoke the URL by any means to install and use an application with no manual intervention.

A preferred URL structure generated URL 2250 is “protocol://tld/path_to_config_file”. The term ‘tld’ in the preferred URL structure may be a ‘tld’ of a runtime or a multi-tenant multi-cloud platform for PAAS and SAAS applications. The ‘protocol’ may be any protocol such as HTTP or HTTPS. The last part of the preferred URL structure is the path to the publicly available configuration file.

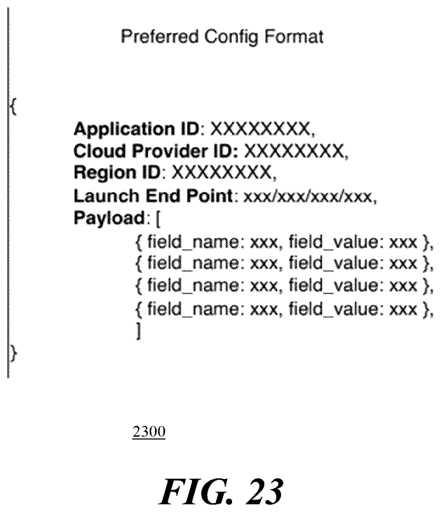

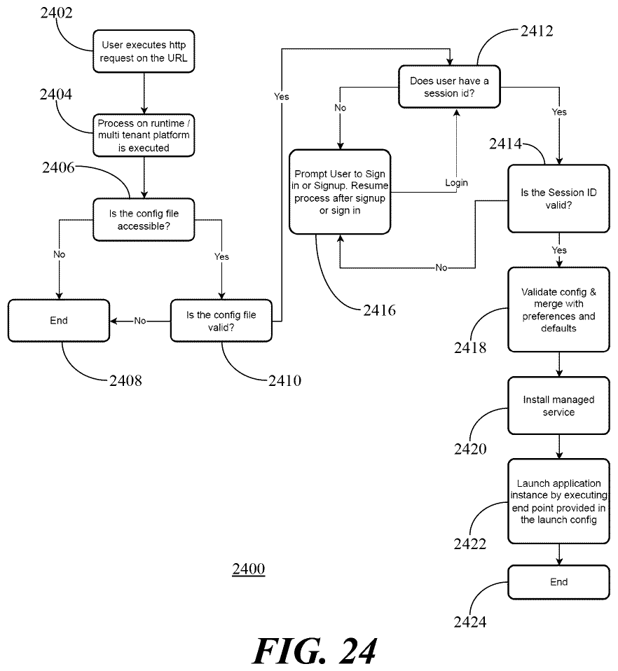

FIG. 23 depicts a preferred structure of a launch config file 2300 in accordance with the present disclosure. The ‘Application ID’ is an ID of the application that needs to be deployed (note that the term “managed service” is interchangeable with “application”). The ‘Cloud provider ID’ is an ID of the public cloud platform in which the application needs to be installed. The Cloud Provider ID may be empty when using user preferences or defaults. In addition, this field may be ignored for private runtimes. The ‘Region ID’ is an ID of the region in which the user would like to install their application. The Region ID may be empty; if the Region ID is empty, the nearest region may be calculated either by using a user's physical address or a user's IP address. This field may also be ignored for private runtimes. The ‘Launch End Point’ is an end point on the application manager that needs to be invoked to cause launching of an application instance. And, finally, the ‘Payload’ is the input data that is passed to the launch end point. The Launch End Point may be empty and, if the launch end point is empty, the launch process may end after the installation of the managed service.

FIG. 24 depicts a flowchart 2400 of an exemplary process of launching a SAAS and PAAS application in one click in accordance with the present disclosure using HTTP protocol. Initially, the user invokes 2402 the http URL using any means. Depending on the TLD, the URL request may end on a runtime, a multi-tenant, multi-cloud, multi-region platform or the repository and the marketplace for managed services for execution 2404. The runtime, platform or repository checks 2406 if the publicly available config file is accessible or not. If the config file is not accessible 2406, the installation process ends 2408. When the config file is accessible 2406, the runtime, platform or repository validates 2410 the config file. If the publicly accessible config file is found to be invalid 2410, the process of installing the managed service ends 2408.

The runtime, platform or repository next checks if the user is logged in 2412 and if the logged in session is valid 2414. The runtime, platform or repository may require the authentication and authorization of the user 2416 for checking, including but not limited, if the user has privileges to install managed services or checking user's stored preferences. If the user is not logged in, the runtime, platform or repository may require user to login 2412 and resume the process 2414 after a successful login. The runtime, platform, or repository may then validate 2418 all the fields of the config file, populate the empty fields with user's set preferences or defaults and generate the final config file. If the final config file is invalid after the step 2418 the user may be notified. The invalidation of the config file at the step 2418 would not be due to syntactic issues, rather it would be due to issues including but not limited to a user's preferences not being set or the runtime ID being nonexistent. After such issues, if any, are resolved, the process of installing the managed service on the runtime or platform specified by the user is performed 2420. The application instance is then launched 2422 after successful installation 2420 of the managed service is carried out and if the config contained the details of the end point on the managed service to be invoked. The process of installing the managed service and optionally an application instance of the managed service then ends 2424.

### Universal Invocation Interface

Generally, PAAS and SAAS applications depend on or make use of other PAAS and SAAS applications. A non-limiting example includes a managed Wordpress service. The managed Wordpress service may depend on other managed services like MySQL service, Elastic Search service, Redis service or others. Most managed services define their own interfaces, authentication schemes, authorization schemes, and similar parameters. This causes several issues including but not limited to tighter coupling of various services, difficulty managing a plurality of credentials, and difficulty in switching dependent services.

In one embodiment, the present disclosure provides methods and systems for defining a common invocation interface which may be used by a plurality of clients for invoking a plurality of services via a common interface. Non-limiting examples of clients may be services depending on other services, components of the runtime, and end users. The common invocation interface is advantageously capable of being used by a gateway for routing all the requests to appropriate managed services. The gateway optionally utilizes a database or an algorithm for identifying the DNS name, the IP address, the location or any other information required for the gateway to proxy the request to the invoked service. The gateway is further capable of invoking the calling service if the invoked service supports non-blocking asynchronous operations. The invocation request optionally contains information for identifying the invoking service by the invoked service, the invoked service using the information for invoking the invoking service on completion of the non-blocking asynchronous operations. The invocation request also optionally contains information specifying methods on how an invoked service may invoke the invoking service.

In one embodiment, the present disclosure provides a method and system for enabling developers to build applications and distribute them globally. The applications can be used by a plurality of clients running workloads on a plurality of platforms or infrastructures. Looked at differently, the present disclosure enables easy distribution of software to a wide variety of clients using various platforms or infrastructures.

### Enabling Reusability of PAAS and SAAS Applications

Building PAAS and SAAS applications is complex. Generally, the complexity involved in building a PAAS and SAAS application is directly proportional to the number of application dependencies a PAAS and SAAS application has. For example, generally a Wordpress application may depend on one or more applications like Apache HTTP, Apache SOLR, MySQL and Redis, whereas Apache Hadoop may depend on one or more applications like Apache Zookeeper. The complexity associated with building a Wordpress service may be higher compared to the complexity associated with building a Hadoop service due to the number of dependent services in Wordpress being higher than the number of dependent services in Hadoop. This may be because developers of Wordpress services may need to learn and be proficient at five independent systems whereas developers building Hadoop services may need to learn and be proficient at two independent systems.

Reusability of PAAS and SAAS applications is enabled in accordance with the present disclosure by providing methods for enabling applications to invoke other applications by use of universal invocation interfaces and ID-based identification of PAAS and SAAS applications. The system and methods in accordance with the present disclosure further enable a developer to focus on their core application while the dependent applications are available to it as a service. The system and methods in accordance with the present disclosure also enable an expert of an application to build and offer the application as a service which can be used by any other developer for integration into their application. The methods and systems in accordance with the present disclosure are further capable of working on a plurality of runtimes capable of interfacing with a repository and marketplace of managed services.

Consider a non-limiting example wherein a Wordpress developer may use a MySQL application built by any developer without having to know how MySQL application works internally. Likewise, consider another non-limiting example of a MySQL application developer using a ProxySQL application built by another developer. The developer of the MySQL application is not required to know how to build a Proxy SQL application.

In another embodiment, the methods and systems in accordance with the present disclosure enable automatic installation of dependent services at the time of invocation. These methods and systems therefore eliminate the need for users to install dependent applications and provide a solution capable of working uniformly on a plurality of runtimes or multi-tenant platform.

In another embodiment, the methods and systems in accordance with the present disclosure assign a globally unique ID to managed services. The assignment of the ID may be done by any system like the electronic repository and marketplace of the managed services. The ID is capable of being used for various purposes including but not limited to identifying, installing and invoking the managed services.

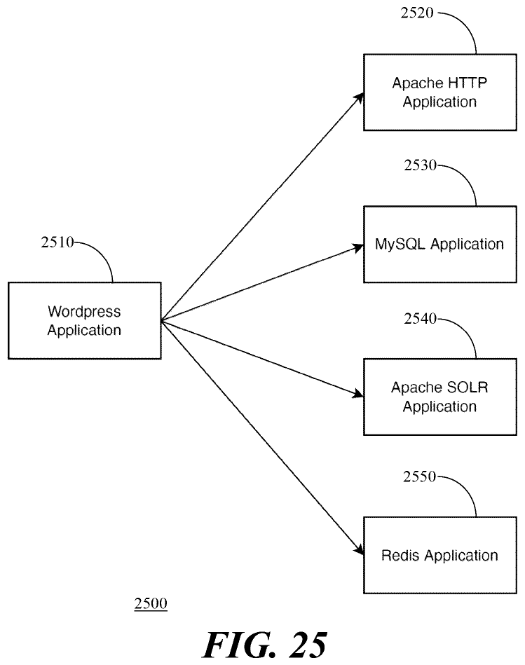

Referring to FIG. 25, a logical representation 2500 depicts a Wordpress service 2510 that depends on an Apache HTTP service 2520, a MySQL service 2530, an Apache SOLR service 2540 and a Redis service 2550. The Wordpress service 2510 may use any functionality provided by any of the dependent services 2520, 2530, 2540, 2550. For example, the Wordpress service 2510 can launch one or more MySQL clusters using the MySQL service 2530. The Wordpress service 2510 can also use the various functionalities of the dependent services 2520, 2530, 2540, 2550 to take backup, to scale up a cluster, to recover from crashes, or to perform other functionalities. In the same way, the Wordpress service may use any other service without having to know or learn the art of management of the dependent application. All of the services shown may be developed by the same or different developers.

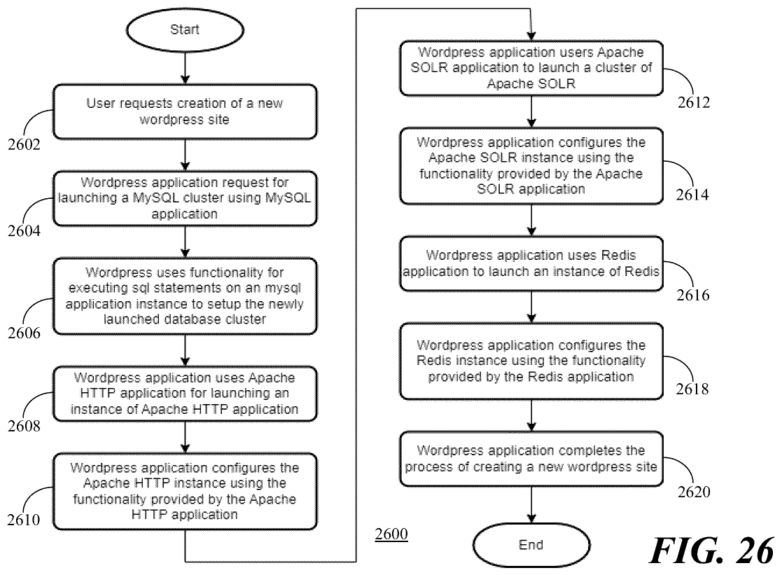

FIG. 26 depicts a flowchart 2600 of an exemplary process of launching a Wordpress application instance referred to as Wordpress site. Initially, a user executes 2602 a request for launching a new Wordpress site. The Wordpress service uses a MySQL service to launch 2604 a new application instance to be used as a database for the new Wordpress site. The MySQL application instance is referred to as a MySQL cluster. The Wordpress service uses 2606 functionality provided by the MySQL service to configure the newly launched MySQL cluster. The Wordpress service then uses 2608 an Apache HTTP service to launch a cluster of http servers. The Wordpress service then uses 2610 the functionality provided by the Apache HTTP service to configure the Apache HTTP application instance. Thereafter, the Wordpress service launches 2612 a new SOLR cluster using the Apache SOLR service. The newly launched service may be used as a search engine for the Wordpress site. The Wordpress service configures 2614 the Apache SOLR application instance for use by the Wordpress site. Then the Wordpress service launches 2616 a new Redis application instance using a Redis service and configures 2618 the Redis service for use. All dependencies needed for functioning of the exemplary Wordpress site have all been created 2620 thereby advantageously providing the Wordpress site with functionality of the Apache HTTP application instance, the Apache SOLR application instance, and the Redis application instance. The new Wordpress site may now be available to be used by the user.

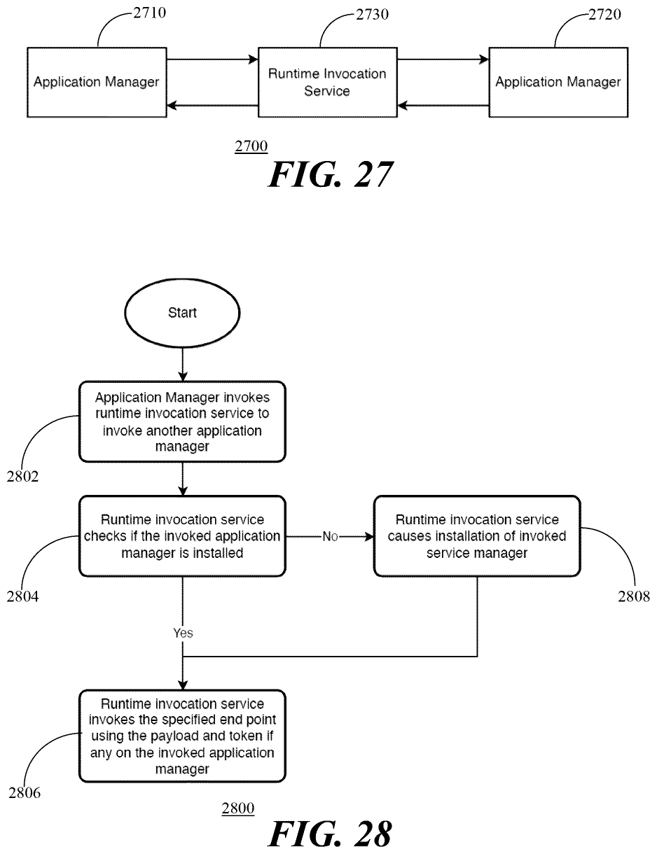

FIG. 27 depicts a diagram 2700 of a first application manager 2710 invoking a second application manager 2720 using an invocation service 2730 provided by a runtime. An instance of the managed service created as part of the installation process is called an application manager. The application manager may be a http server if the managed service is built using http. The application manager is also referred to as a service manager or a managed service manager. The runtime invocation service 2730 may also be referred to as a Managed Service Invocation Gateway.

The application manager 2710 may invoke any other application manager 2720 by using a unique ID of the service being invoked; the endpoint on the application manager being invoked if the application manager is an http server; a payload to be passed to the application manager being invoked; and, optionally, a token for idempotency and identification of callbacks in case of non-blocking asynchronous requests. The endpoint being invoked may result in execution of a synchronous process or an asynchronous process. In the case of a synchronous process, the invoked application manager 2720 returns the response to the invocation service 2730, which passes the response to the invoking application manager 2710. In the case of an asynchronous process, the invoked application manager 2720 can use the invocation service 2730 to invoke the callback end point of the invoking application manager 2710. The invoked application manager 2720 may optionally pass the token passed by the invoking application manager 2710 to the runtime invocation service 2730 during the time of the invocation.

FIG. 28 depicts a flowchart 2800 further illustrating the invocation process in accordance with the present disclosure. The invoking application manager 2710 uses the invocation service 2730 provided by the runtime to invoke 2802 the other application manager 2720. The runtime invocation service 2730 checks 2804 if the invoked application is installed on the runtime. If the invoked application is already installed and available 2804, the runtime invocation service invokes 2806 the application. If the invoked application is not installed 2804, the runtime invocation service triggers the process for installation 2806 of the invoked application and then causes invocation 2806 after installation of the invoked application. The installation process may be carried on the first invocation.

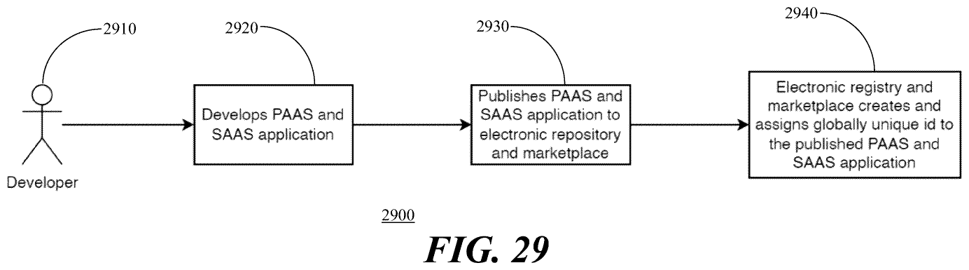

FIG. 29 depicts a diagram 2900 showing assignment of a global unique ID for identification of PAAS and SAAS applications. A developer 2910 programs a PAAS and SAAS application 2920 and publishes the programmed application on an electronic repository and marketplace of PAAS and SAAS applications 2930. A process on the electronic repository and marketplace creates and assigns a globally unique ID to the published PAAS and SAAS application 2940. The globally unique ID may be used by any developer to invoke the application via the runtime invocation service without having to know if the application is installed or not and without having to know other details of the managed service like the DNS name, the IP address or any other information which would have been needed if the runtime invocation service was not available.

Developers are enabled in accordance with the present disclosure to rapidly build new PAAS and SAAS applications by several means. One of the means advantageously involves enabling reusability of PAAS and SAAS applications built by any developer. Reusability of PAAS and SAAS applications enables developers to focus on their core application while leaving the dependent applications to experts of the dependent application.

Dependency of one application on another application gives rise to dependency problems colloquially termed as “dependency hell”. Dependency issues generally arise when a plurality of services depend on a same service but they depend on different and incompatible versions of the service. Such dependency issues may prevent users from installing and using certain services. This may further cause users to choose between applications due to version conflicts. Dependency issues may also prevent updates to services if any service depends on an older version of a service. Automatic upgrades of managed services in such scenarios may also break dependent managed services.

Furthermore, as a plurality of managed services may depend on each other and a plurality of managed services may be built by a plurality of developers, the pace of development of each managed service may be different. This may create a problem for users where a user may not be able to install and use a latest version of a managed service as other managed services may be using the older version of the managed service. Further, a managed service may be in the middle of performing important operations like scaling up, backup or restore at the time of an update and the update to the managed service should ensure the ongoing operations may not be affected due the update.

Allowing installation of multiple versions of a managed service would be an inefficient solution. Accordingly, methods and systems in accordance with the present disclosure address the problem of dependency issues and enables live and automatic updates of all installed managed service to ensure all managed services are up to date. The methods and systems further eliminate the process of manual installation of dependent services by the users.

The methods and systems in accordance with the present disclosure require developers to provide versioned interface to their application. A non-limiting example is a MySQL application implemented as an http server providing “/v1/cluster/launch” as an endpoint path to launch a new MySQL cluster, wherein v1 is the version of the managed service. The methods and systems further prevent developers from deprecating old versions of the interface if the interface is in use by the managed service.

The methods and systems in accordance with the present disclosure further advantageously include a process to ensure all new applications use the latest interface version enabling gradual elimination of use of older versions of the interface. The methods and systems further enable developers to deprecate older versions of the interface which may no longer be used by any managed service on a plurality of runtimes.

Finally, the methods and systems in accordance with the present disclosure further include a process to watch for availability of updates of managed services and cause automatic update of the installed managed services when such updates are available.

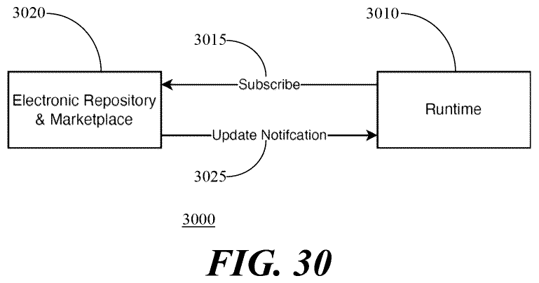

FIG. 30 depicts a diagram 3000 of an application update monitoring process in accordance with the present disclosure. A runtime 3010 subscribes 3015 to receive notifications of updates by electronic means as and when new updates to a managed service are available. Update notifications 3025 may be provided by any system including but not limited to an electronic repository and marketplace of managed services 3020. The electronic registry and marketplace 3020 pushes notification updates 3025 by electronic means to the subscribed runtime 3010 as and when updates to an application are available. The application update manager 1470 component of the runtime 1410 (FIG. 14) causes managed services to be updated as and when a new update becomes available.

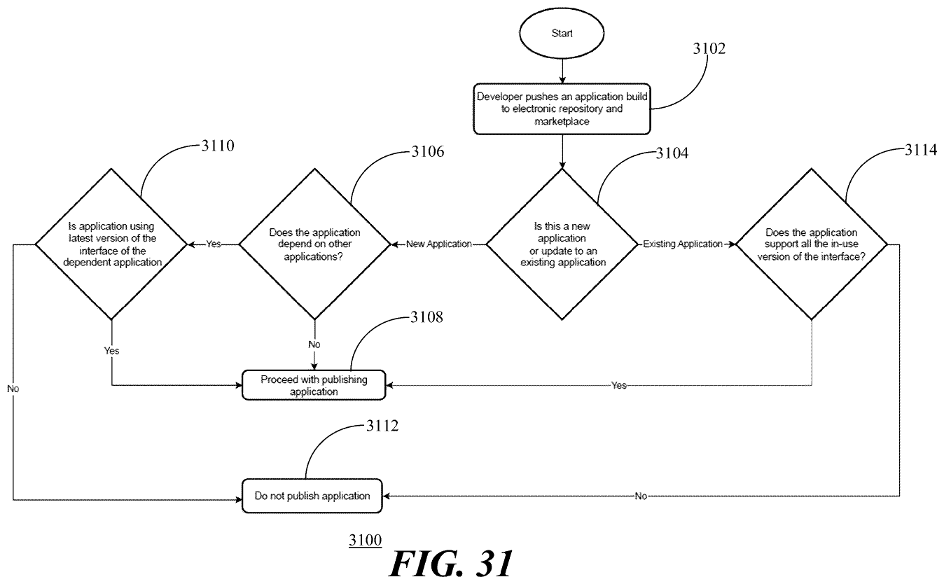

Referring to FIG. 31, a flowchart 3100 depicts a process of publishing an application. All managed services undergo checks to ensure backward compatibility of versioned interfaces. The checks ensure usage of the latest version of the application interface. The process starts with the developer pushing 3102 a build of a managed service (also called as application) to an electronic repository and market place. The electronic repository and marketplace determines 3104 if the pushed managed service is a new service or not. If the pushed managed service is a new managed service 3104, the process will ascertain 3106 if the new service uses other services (i.e., depends upon other applications). Ascertaining if a service uses other managed services 3106 may be performed via various means including but not limited to specifying a list of dependent services by the developer in the managed service manifest. If the managed service being published does not depend on any other managed services 3106, the publishing of managed service is allowed 3108. If the managed service depends on other managed services 3106, a check is performed 3110 to ensure the managed service being published uses the latest available version of the dependent managed services. If the managed service being published is using the latest version of the interface of the dependent managed services 3110, the managed services is allowed to be published 3108. If the managed service being published does not use the latest version of the interface of the dependent managed services 3110, the publishing of the managed services is disallowed 3112.

If the managed service being published is an already published managed service 3104, the published process is to be considered as an update and a check is performed 3114 to ensure the managed service update that is requesting publication includes support for all the in-use interface versions. If the managed service update being published supports all the in-use interface versions 3114, the managed service updated is allowed 3108 and if the managed service update does not support one or more prior versions of the interface 3114, the managed service update is disallowed at 3112.

The developed applications may run on infrastructure owned or controlled by the clients or in other instances the developed applications may run on multi-tenant runtimes where clients do not own or control the infrastructure. In addition, the developed applications may depend on one or more applications. The dependent applications may further depend on other applications and this dependency chain may extend to infinity.

The developers of an application may want to charge clients. Different developers may want to charge their clients in different ways. The developers may also want to create pricing tiers to offer differentiated pricing based on the level of usage by each client. This introduces the problem of enabling a plurality of software vendors (developers) with a plurality of software licenses and a plurality of pricing options from a plurality of dependent applications to charge their clients according to their licenses and pricing options.

In one embodiment the methods and systems in accordance with the present disclosure enable software vendors to offer their users simple pricing options that abstracts away the complexity associated with the pricing of complex software. Non-limiting examples of pricing options are (a) time-based billing such as monthly or annual subscriptions, (b) fixed time-based billing per metric such as a maximum number of CPU cores per month, a total RAM per month, or a number of users per month, (c) usage-based billing per metric (also known in the art as a “pay as you go” model) such as a total RAM hour consumed in a month or a number of user days, and (d) feature-based billing such as auto crash recovery or standby for high availability.

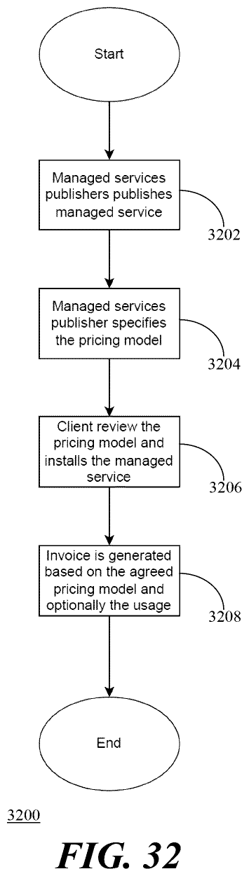

FIG. 32 depicts a flowchart 3200 of an overview of a process for pricing of managed services in accordance with the present disclosure. A managed services developer pushes 3202 a managed service to an electronic repository and marketplace and the developer of the managed service specifies 3204 a pricing model. A client reviews 3206 the managed service along with the pricing model and installs the managed service. A billing amount is then determined 3208 based on the pricing model and, optionally, the usage metrics, and an invoice is generated.

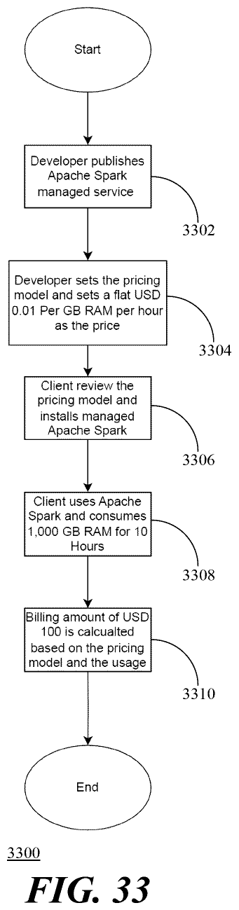

FIG. 33 depicts a flowchart 3300 of an overview of a process for billing of managed services in accordance with the present disclosure. A developer publishes 3302 a managed Apache Spark service to an electronic repository and marketplace. The developer sets 3304 a usage-based pricing model and determines the price as USD 0.01 per GB RAM per hour for the RAM consumed by all the Spark clusters launched using the managed service. A client reviews 3306 the pricing of the managed service and installs the managed service. The client then uses 3308 the Apache Spark managed service to run a spark job that consumes 1,000 GB RAM for 10 hours. A total billable amount of USD 100 is calculated 3310 based on the developer's pricing model and the client's usage.

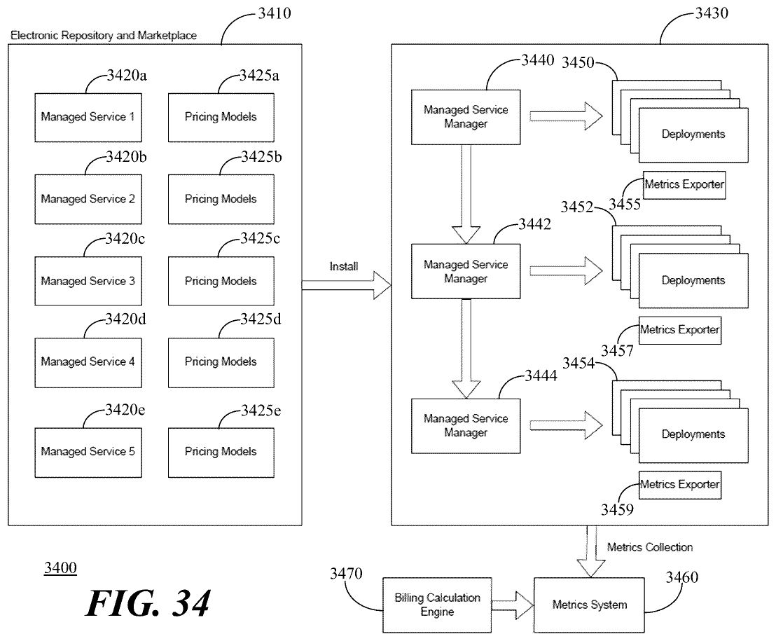

FIG. 34 depicts a diagram 3400 of a process of billing for a usage-based pricing model in accordance with the present disclosure. An electronic repository and marketplace 3410 contains a plurality of published applications 3420a, 3420b, 3420c, 3420d, 3420e and a plurality of pricing models 3425a, 3425b, 3425c, 3425d, 3425e. The pricing models 3425a, 3425b, 3425c, 3425d, 3425e may be based on fixed cost models or usage-based models. A published application may be associated with the plurality of pricing models 3425a, 3425b, 3425c, 3425d, 3425e or one or more of the plurality of pricing models 3425a, 3425b, 3425c, 3425d, 3425e. A published application may also be associated with either one or both of the fixed cost pricing models and the usage-based pricing models. A logical representation 3430 depicts the installed applications and the application instances on an exemplary runtime. An application manager 3440, also called as Managed Service Manager, manages one or more application instances 3450 called Deployments. The Deployments 3450 are associated with metrics exporters 3455. Each of the Deployments 3450 may be associated with a separate metrics exporter, or all the Deployments 3450 may use one common metrics exporter 3455, as shown.

The managed service 3440 may optionally depend on another managed service 3442 which may further depend on another managed service 3444. The managed service manager 3442 manages one or more deployments 3452 and an associated metrics exporter 3457, and the managed service manager 3444 manages one or more deployments shown 3454 and an associated metrics exporter 3459.

A metrics system 3460 collects application metrics and host metrics from all the metrics exporters 3455, 3457, 3459 in a runtime and makes them available to various components for various purposes. A Billing Calculation Engine 3470 utilizes the pricing models 3425a, 3425b, 3425c, 3425d, 3425e of the managed services 3420a, 3420b, 3420c, 3420d, 3420e and metrics from the metrics system 3460 to calculate a billable amount for a plurality of clients and their managed services.

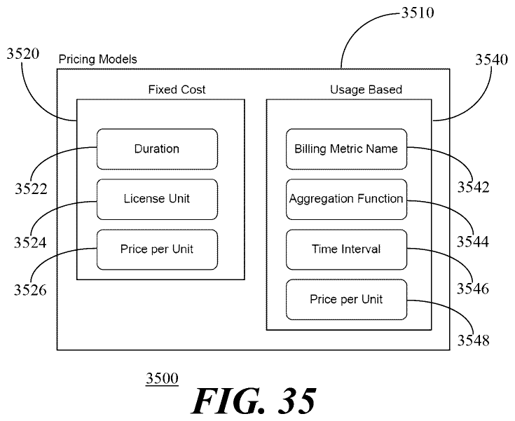

FIG. 35 depicts a diagram 3500 of an overview of types of pricing models 3510 in accordance with the present disclosure. A pricing model 3510 (or billing model) can be of two types: a fixed cost billing model 3520 or a usage-based pricing model 3540. A fixed cost billing model 3520 can be used for licensing models which offer licenses per unit, like CPU cores, and do not care about usage of the software. The fixed cost billing model 3520 calculates a billed amount based on a duration 3522 for which the purchased license would be valid, a licensing unit 3524 and a price per license per billing unit 3526. Non-limiting examples of a licensing unit 3524 include CPU cores, servers, or users.

The usage-based pricing model 3540 includes a Billing Metric Name 3542. The Billing Metric Name 3542 can be any metric associated with the application or the logical asset running the server which is measured for billing purposes. Non-limiting examples of billing metrics include RAMs, CPUs, number of connections, number of users, read latency, or write latency. A Software vendor may choose to bill a user based on any available metric. For example, a developer can offer a database managed service and bill users based on an average RAM being consumed per hour. An aggregation function 3544 specifies how to roll up the metrics to a time interval 3546 and generate a billed amount based on a price per unit 3548.

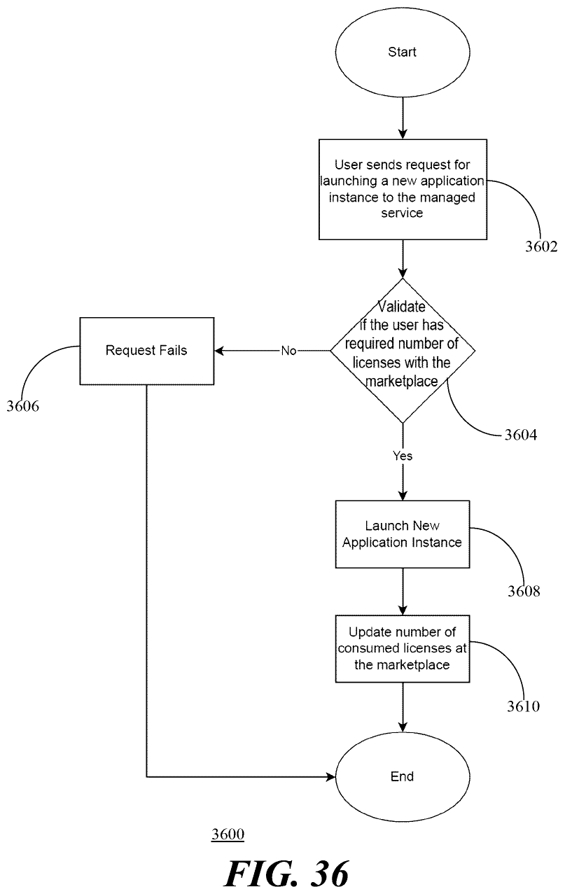

FIG. 36 depicts a flowchart 3600 of a first process for usage of a fixed cost licensing model in accordance with the present disclosure, the first process using the fixed cost licensing model over a plurality of runtimes at the time of launching new application instances. The runtimes can be either single tenant or multi-tenant. An exemplary client or user starts the process of launching an application instance by sending 3602 a request to a managed service. The managed service validates 3604 if the client has the required number of valid licenses. If the client does not have the required number of valid licenses 3604, the client's request for launching an application instance fails 3606. On the other hand, if the client has the required number of valid licenses 3604, the request moves forward and the managed service starts the process of launching application instances 3608. After the successful installation of the application instances, optionally, the managed service updates 3610 the marketplace on the number of licenses consumed. It is important to note that the validation of licenses 3604 and the updating of licenses 3610 may happen in one step to avoid race conditions.

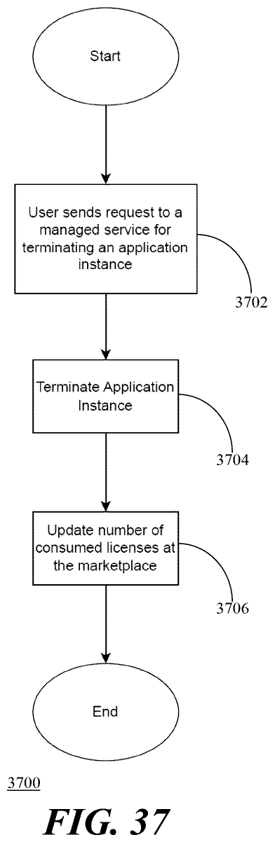

FIG. 37 depicts a flowchart 3700 of a second process for usage of a fixed cost licensing model in accordance with the present disclosure, the second process using the fixed cost licensing model at the time of termination of an application instance. Initially, a user sends 3702 a request to a managed service to terminate an application instance. The managed service terminates 3704 the application instance. After successful termination 3704, the managed service updates 3706 the marketplace to release the consumed licenses if the licenses were not expired.

It is important to note that the validation or updating of licenses may happen on any event and not just at the time of launching or terminating application instances. Non-limiting example of such events include auto scaling, adding new users, and expiration of licenses.

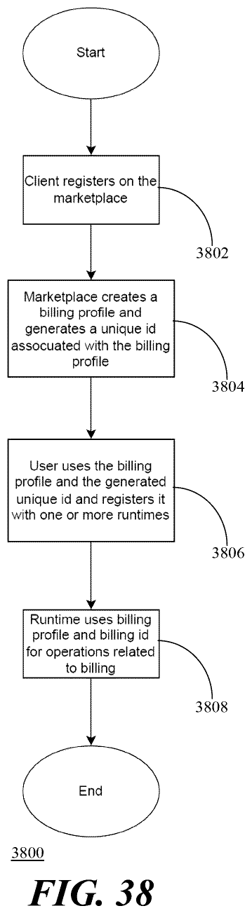

FIG. 38 depicts a flowchart 3800 of a registration process of a client with a marketplace in accordance with the present disclosure. At the start of the process, the client registers 3802 with the marketplace. The marketplace generates 3804 a billing profile and may also generate a unique billing profile ID. The client then uses the marketplace billing profile with the unique id, if any, for associating 3806 the billing profile with a runtime ID. The user may associate 3806 a billing profile with a plurality of runtimes. The runtime then uses 3808 the billing profile for identification of the client for operations related to billing. Non-limiting examples of operations related to billing are validating licenses, consuming licenses, and releasing licenses.

### Infrastructure Agnostic Multi Tenant Platform

Not all users have the technical expertise or manpower with the required technical expertise to install and use runtimes. While installing runtimes on devices may be relatively simple, installing runtimes on centrally hosted infrastructure such that the runtime and apps installed on the runtime can be used by a plurality of users may be complex. It should be possible for users, whether technical or not, to be able to use managed services programmed using a general computing abstraction without having to install or manage infrastructure.

Further, users may have preferences on the choice of cloud platform, infrastructure, or locations they would like their managed services to run on. The choices may be determined either based on preferences or based on regulatory requirements.

In accordance with the present disclosure, a managed multi-tenant, multi-cloud, multi-platform, multi-region system is provided that advantageously enables installation and use of managed services built using the general computing abstraction by a plurality of clients. The clients may be different organizations or users belonging to different organizations. The system is beneficially capable of enabling users to choose infrastructure or locations they would like to run their applications on.

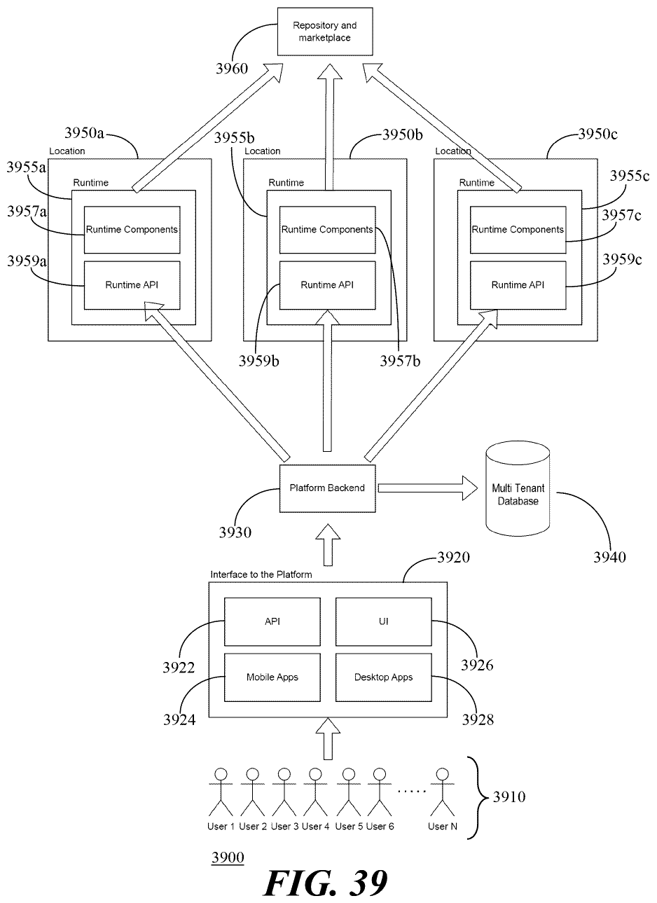

FIG. 39 depicts an illustration 3900 of a multi-tenant, multi-platform, multi-cloud, multi-region system in accordance with the present disclosure. A plurality of users 3910 may access the system via any available interface such as the exemplary interface 3920. The users may belong to the same or different organizations. The interface 3920 and a backend 3930 provide an interface for management of managed services running on a plurality of locations and plurality of runtimes. An API 3922, mobile apps 3924, a user interface (UI) 3926, and desktop applications 3928 are non-limiting examples of interface options which may be available for the users 3910.

The tenant-aware backend 3930 is responsible for one or more features including but not limited to user registrations, installation of applications as per user's choice of location and other options made available to the user, and usage monitoring and is coupled to a multi-tenant data base 3940 to track the tenant's features. Non-limiting examples of choices that may be presented to a user may be cloud platform, location, infrastructure, or private runtimes. The platform backend 3930 interfaces with one or more runtimes 3955a, 3955b, 3955c at one or more locations 3950a, 3950b, 3950c. While the illustration 3900 depicts one runtime per location for simplicity and ease of understanding, a location may be host to a single runtime or a plurality of runtimes. The locations 3950a, 3950b, 3950c may be any location globally.

The runtimes at 3955a, 3955b, 3955c may contain various runtime components 3957a, 3957b, 3957c such as any of the various runtime components described hereinabove. The platform backend 3930 interfaces with runtime APIs 3959a, 3959b, 3959c and uses the runtime APIs 3959a, 3959b, 3959c for causing all necessary actions to enable installation and usage of managed services. The platform backend 3930 may include a tenant identifier in one or more of its communications with the runtimes 3955a, 3955b, 3955c. The runtimes shown 3955a, 3955b, 3955c may interface with a repository and marketplace 3960 of managed services for various means including but not limited to installation of managed services, licensing, and managed services updates.

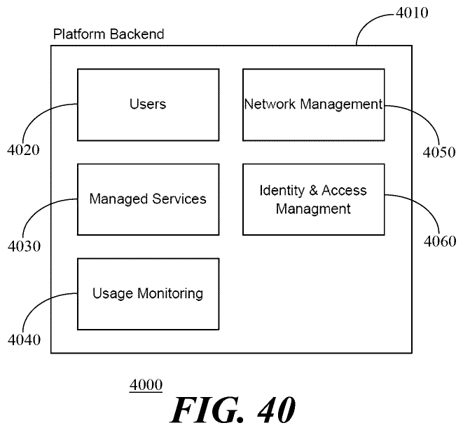

Referring to FIG. 40, a diagram 4000 depicts an example of a platform backend 4010 in accordance with the present disclosure. A user management module 4020 supports features including but not limited to user registration, organization creation, and user credentials management. A managed services module 4030 supports features including but not limited to interfacing with the repository and marketplace to fetch a list of available managed services, cause installation of managed services based on a user choice, and cause uninstallation of managed services. A usage monitoring module 4040 supports features including but not limited to generation of reports and view of reports. The reports may be created using metrics available from a plurality of runtimes. A network management module 4050 offer users the ability to manage networking for a plurality of applications running on a plurality of runtimes and an identity and access management module 4060 manages users IDs and additional information necessary for the user to access various managed services and various runtimes.

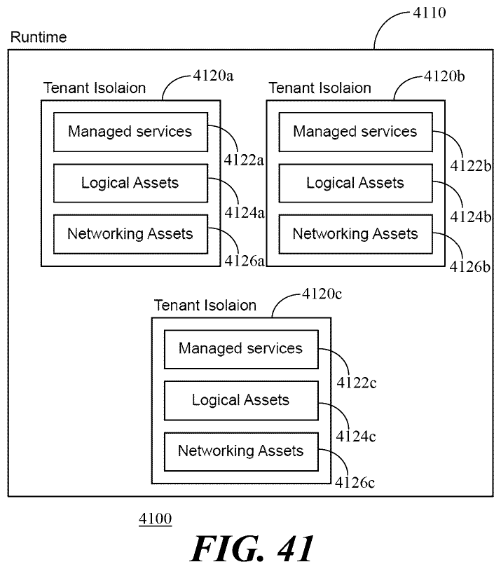

FIG. 41 depicts a diagram 4100 of an exemplary runtime 4110 such as one of the runtimes 3955a, 3955b, 3955c (FIG. 39). The exemplary runtime 4110 is being used for installation and usage of managed services by a plurality of tenants and is tenant aware and causing creation of logical assets in an isolated fashion such that there is separation between tenants such that the tenants are isolated from each other's resources. Tenant Isolations 4120a, 4120b, 4120c are logical depictions of isolation between tenants. The isolation which isolates resources includes but is not limited to Managed Services 4122a, 4122b, 4122c, Logical Assets 4124a, 4124b, 4124c, and Networking Assets 4126a, 4126b, 4126c.

### Private SAAS

SAAS applications are generally hosted centrally and are generally accessible over public networks. It is known to people skilled in the art that no systems are perfectly secure and there is always risk of a leak of data. Moreover, many SAAS solutions do not offer easy and absolute data sovereignty.

To overcome concerns of security and isolation, many organizations self-host SAAS applications on their premises. To meet this need, many SAAS service providers offer services for installing and maintaining their SAAS application on premise. This approach for attaining better security is usually expensive and is generally used by large corporations.

In accordance with the present disclosure, a means of developing and distributing SAAS applications that can be self-hosted easily and by anyone is provided. The SAAS applications can be run either using runtimes or can be installed and used on a managed multi-tenant, multi-cloud, multi-region platform. The developed SAAS applications are capable of running on closed or controlled networks and offering absolute data sovereignty.

Building multi-tenant managed services is extremely challenging as can be appreciated by a person having skill in the art. Consider a non-limiting example of an attendance tracking application for a school. A single tenant application designed for a specific school to be used by teachers for marking students being present or absent is a relatively simple application to build. However, to convert the application into a SAAS service which can be used by a plurality of clients is very challenging as it involves challenges related to security, scaling, architecture to handle multi-tenancy, management of dependent applications like databases, caches, and search servers, deployment of the services, and many other challenges.

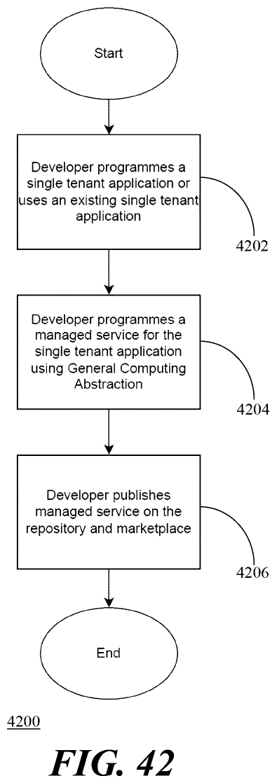

In accordance with the present disclosure, a method and systems for quickly converting a single tenant application into a managed service which can be used by a plurality of clients as a service managed service like a PAAS or a SAAS application is provided. FIG. 42 depicts a flowchart 4200 of a process of converting a single tenant application into a managed service in accordance with the present disclosure. At step 4202, a developer programs or uses an available single tenant application. The single tenant application may be programmed in any programming language and optionally may be capable of being run as a container. The developer then programs 4204 a managed service for the single tenant application using an interface for General Computing Abstraction. If the general computing abstraction interface is implemented as an http server, the developer will use the HTTP API for building the managed service. Optionally, the developer may next publish 4206 the programmed managed service on a repository and marketplace.

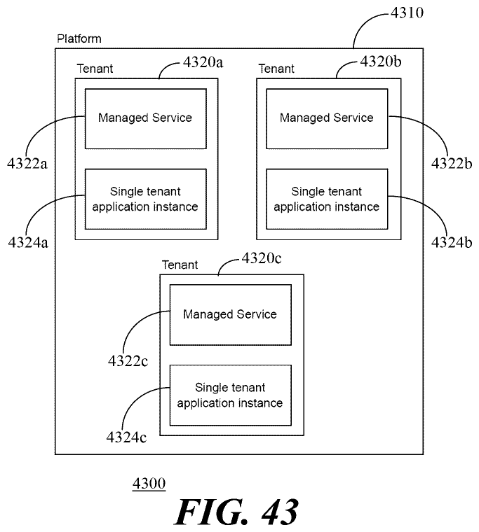

FIG. 43 depicts a logical overview diagram 4300 of a multi-tenant platform 4310 capable of installing and running managed services built using a General Computing Abstraction. Exemplary isolated tenants 4320a, 4320b, 4320c have installed respective managed services 4322a, 4322b, 4322c. The managed services 4322a, 4322b, 4322c are responsible for managed instances of a single tenant application such as exemplary single tenant applications 4324a, 4324b, 4324c.

Building PAAS and SAAS applications is complex, time consuming and capital intensive. A typical PAAS and SAAS application, also referred to as a managed service or application, requires many systems to be built including systems for authentication and authorization. Authentication is the act of establishing the identity of a client and authorization is the act of determining if a verified client has the privilege to take an action or not. Building of several systems like authentication and authorization increases the time and effort required for building managed services. On the other hand, creating and managing users for each independent PAAS and SAAS application and setting user's access rights is time consuming and cumbersome for the administrators. Lastly, the users authorized for accessing PAAS and SAAS management consoles may find remembering credentials for a plurality of services tedious and difficult.

In accordance with the present disclosure, methods and systems for enabling authentication and authorization for managed services without writing any code is provided. The methods and systems enable administrators to create users and grant the created users access to a plurality of managed services. The managed services may be programmed by one or more developers, the developers belonging to one or more entities. The methods and systems enable users responsible for management of managed services to use a single identity to manage a plurality of managed services programmed by the one or more developers belonging to the one or more entities.

In a further embodiment, the present disclosure provides a no code solution for enabling authorization for services. The services may include microservices and the services are capable of being accessed by clients over a network like the internet.

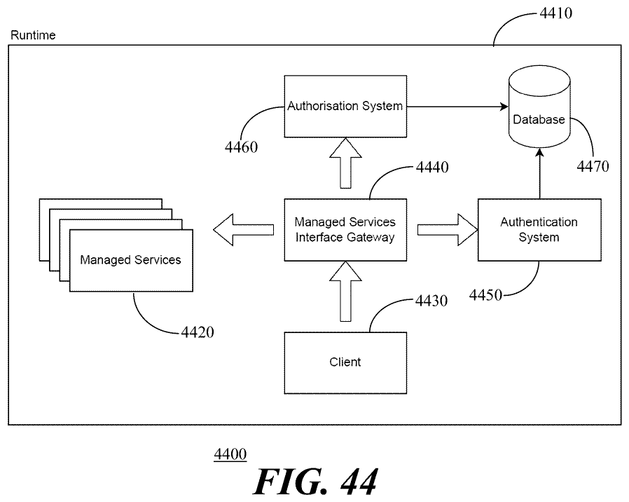

Referring to FIG. 44, an illustration 4400 depicts an exemplary workflow of a user using managed services installed on an exemplary runtime 4410. The runtime 4410 includes a plurality of installed managed services 4420. A client 4430 may intend to send a request to one of the installed service managers. Non-limiting examples of clients are end users, managed services, managed services application instances, and runtime components. The client 4430 sends a request to a managed services interface gateway 4440. The managed service interface gateway 4440 is a computer implemented method capable of being used via a plurality of protocols. The managed service interface gateway 4440 may specify a fixed format of the interface the client 4430 to use. Upon receiving the request for invoking a managed service, the managed services interface gateway 4430 may first authenticate the user by interfacing with an authentication system 4450. The authentication system 4460 and the process of authentication are described hereinbelow. Upon successful authentication of the client 4430, the managed services interface gateway 4440 may check if the client 4430 is authorized by interfacing with an authorization system 4460. Both the authentication system 4450 and the authorization system 4460 access a database 4470 for their respective tasks. Upon successful authorization of the client 4430, the managed services interface gateway 4440 invokes the requested managed service 4420.

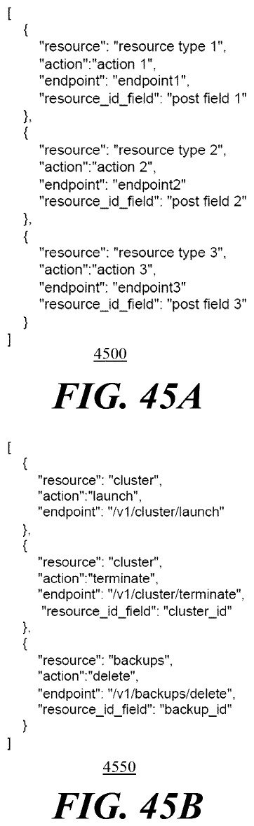

FIGS. 45A and 45B depict configuration files in accordance with the present disclosure which show exemplary declaration of resource types and actions made available by a managed service to its users. The resource types and actions are mapped to http endpoints if the managed service is an http server. The managed service may map the resources and actions to functions if the managed service is implemented as functions. Likewise, the resource types and actions may be associated with any processor executable code. The declaration in the configuration file 4500 of FIG. 45A also includes an optional resource_id_field. The resource_id_field may identify a post parameter or get parameter that contains the resource id the action is being carried out on. The configuration file 4500 presents a preferred format of resource types and actions mapped to http endpoints. The declaration in the configuration file 4500 may be obtained from a managed service in any other manner, the depicted manner being chosen for ease of explanation.

The configuration file 4550 in FIG. 45B is an exemplary declaration of a MySQL managed service making available two resource types. The cluster resource type has two actions—launch and terminate. The launch action does not specify any resource_id_field, whereas the terminate action specifies a name of the http get or post parameter which will identify the specific cluster to be terminated. The backups resource has a delete action and the delete action of the backup resource type may optionally have a backup ID which specifically identifies the backup a client may be acting on. The resource types and actions are mapped to the respective http endpoints responsible for executing the action on successful invocation.

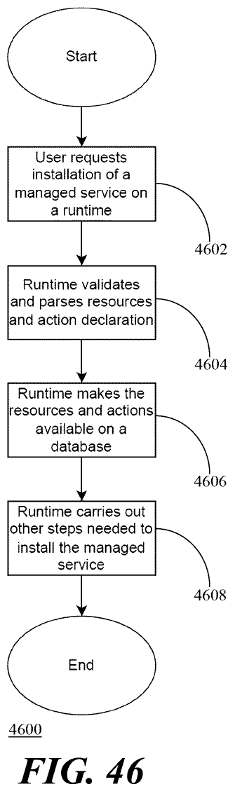

FIG. 46 depicts a flowchart 4600 showing a process of installing a managed service on a typical runtime in accordance with the present disclosure. The process specifically focused on steps related to authentication and authorization system. Initially, a user requests 4602 installation of a managed service. The installation may be caused by any means made available to the client by a runtime. The runtime obtains 4604 the resource types and actions declaration from the managed service. The resource types and actions may be contained in code, in a manifest file or any other means specified by the general computing abstraction or the runtime. After obtaining 4604 the information, the runtime validates the information to ensure it is correct syntactically. The runtime then adds 4606 the resource types and actions information to a database which may be accessible by other components in the system. Non-limiting examples of components capable of querying the database are authorization systems, and multi-tenant platform backends. The runtime then carries out 4608 all the other methods for completing the installation of the managed service.

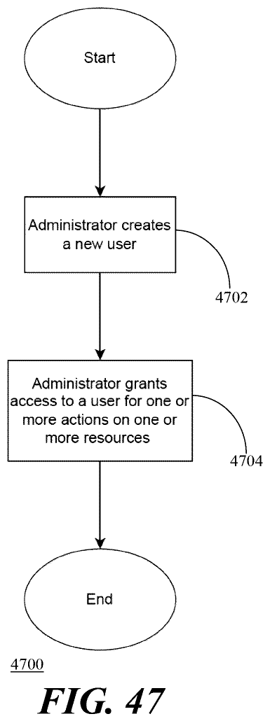

FIG. 47 depicts a flowchart 4700 of a process of an administrator creating users and granting users access to actions on the resources made available by the managed services in accordance with the present disclosure. First, the administrator creates 4702 a user by making use of the interfaces made available by the runtime or the multi-tenant platform. The administrator may further grant access 4704 to the created user to take a plurality of actions on a plurality of resource types made available by a plurality of service managers. The resource types and actions available for a managed service were processed and stored in a database as shown in step 4606 (FIG. 46). The administrator may further specify other possible limitations available for an action, such as the resource IDs.

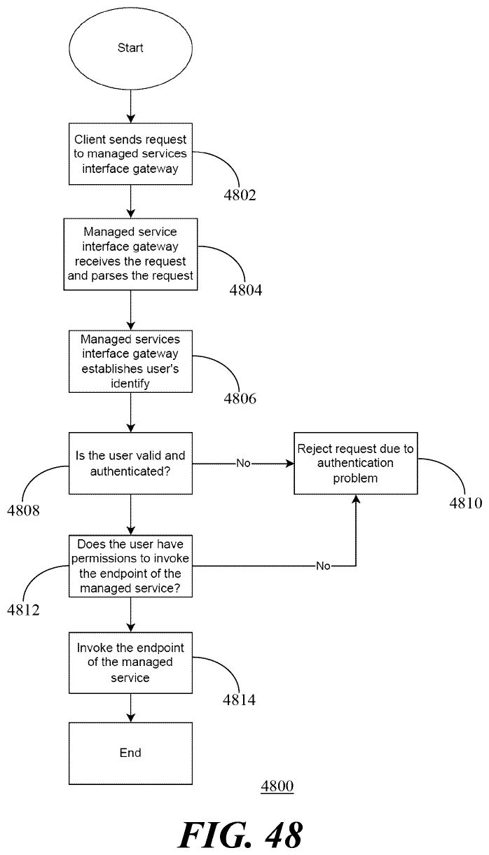

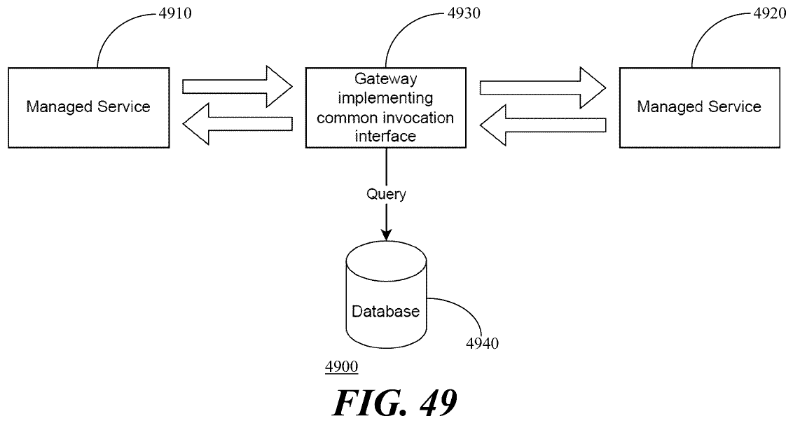

FIG. 48 depicts a flowchart 4800 of a process of authentication and authorization in accordance with the present disclosure. First, a client sends 4802 a request for invoking the interface made available by the managed service. The managed service interface gateway receives 4804 the request and parses the request. If the request is an http post request, the managed service interface gateway processes the post fields to identify required fields. The managed service interface gateway then establishes 4806 the identity of the client invoking the interface of the managed service. If the identity of the client cannot be verified 4808, the request is rejected 4810. After successful authentication 4808 of the client, the managed service interface gateway will proceed to authorize the user 4812. The managed service interface may provide the authentication system details of the managed service being invoked and the user invoking the managed service. Some of the details may have been obtained by parsing the invocation request and such details may include, but may not be limited to, the unique ID assigned to the managed service, the end point being invoked, the resource name, the action name, the user ID, or the resource ID. The managed service may query the database to determine if the user has access to take an action on the resources or the specific resource. The authorization system may use one, some or all of the information provided by the managed service interface gateway to perform an authorization check. If the authorization check 4812 fails, the request will be rejected 4810. After successful authentication 4808 and authorization 4812 checks, the managed service interface gateway invokes 4814 the endpoint on the managed service.

As discussed, PAAS and SAAS applications are complex to deploy and run. Deploying PAAS and SAAS applications on any infrastructure requires in-depth knowledge of the infrastructure the applications are being deployed. Deploying a PAAS and SAAS application on a plurality of infrastructures and platforms is proportionally more complex. Generally, PAAS and SAAS applications are coupled with the platform and infrastructure they are deployed on making the process of deploying a PAAS and SAAS application on multiple platforms and infrastructures very complex.

In accordance with the present disclosure, a method and system for using a common gateway as a means of signing API requests is provided. The system enables the invoking service to invoke services without acquiring any credentials. The system further enables centralized management and easy rotation of credentials.

FIG. 49 depicts a diagram 4900 of two managed services 4910, 4920 programmed either by a same or different developer that are capable of invoking the other managed service by the use of a universal invocation interface and gateway 4930 implementing a universal invocation interface. The universal invocation interface may be implemented by any entity. A managed service 4910 may invoke another managed service 4920 and the invoked managed service 4920 specifies an interface which may be used by any client. The universal invocation interface provides clients a means to specify information that is sufficient and necessary for the system implementing the universal invocation interface like the gateway 4930 to invoke the managed service. The gateway 4930 implementing the universal invocation system is capable of invoking managed services. If managed services are implemented as HTTP services, the gateway 4930 is capable of invoking HTTP endpoints of the managed services. Similarly, managed services may be invoked using gRPC or message queues and the gateway 4930 is capable of invoking using gRPC and/or message queues. The gateway 4930 uses a database 4940 for discovery of managed services. The gateway 4930 may use a unique identifier of managed services to identify the invoking and invoked managed services. The unique ID may also be used by the invoking managed service to identify the invoked managed service. The gateway 4930 may also use an algorithm or any other means for discovery of managed services. The discovery process involves finding the DNS name, IP address or any other information required by the gateway 4930 for invoking the managed service.

The method and systems in accordance with the present disclosure enables developers to rapidly build new PAAS and SAAS applications by several means. One of the means is enabling developers to build a user interface for PAAS and SAAS applications without having to write code.

The ability to build a user interface for managed services without having to learn user interface (UI) technologies or write any code enables developers to build complete managed services end to end very quickly. The disclosed methods and systems provide means for developers to declare the UI in a defined markup presented in accordance with the disclosure. The defined markup possibilities provided in accordance with the present disclosure provide a plurality of UI elements with a plurality of properties. The declared UI is optionally capable of being transpiled into an Abstract Syntax Tree, the Abstract Syntax Tree capable of being rendered on a browser.

Platforms like cloud computing platforms offer a wide variety of choices in terms of the hardware that may be used to run applications. Non-limiting examples of choices may be types of virtual machines and types of storage volumes. Numerous permutations of hardware choices are possible when considering public cloud platforms, private clouds, private data centers, computing devices, and other similar hardware. It is generally very challenging and sometimes considered impossible by persons having ordinary skill in the art to create truly hardware agnostic applications which may run on a plurality of infrastructures without any modification to the code.

Moreover, innovations will lead to creation of more choices of hardware to choose from. A truly agnostic service may not just factor in choices available today but may have to be agnostic to all possible choices that may be available in the future. The methods and systems in accordance with the present disclosure present solutions to create applications and/or managed services that are hardware agnostic and may be used by clients for running applications on the hardware of their choice.

In one embodiment, the present disclosure provides a method and system for development of managed services that are hardware agnostic. The method and system further enable clients to specify any of the hardware choices available to the clients for running their applications.

The disclosed methods and systems provide developers the ability to ask users for hardware choices in a key value format without knowing the available choices at the development time and then pass the client's choice to a runtime. The runtime is capable of executing requests for creation of logical assets as per the hardware specification indicated by the client. The methods and systems further enable runtimes to declare hardware choices available on the runtime. The choices may be used by the managed service to make them available to the clients for their choice. The methods and systems further enable runtime administrators to determine default hardware choices for logical assets which may be created by the runtime. The default choices enable creation of logical assets as per the default choices in the absence of a choice from the client. The systems and methods further provide administrators the ability to enable default choices for an entire runtime or for specific managed services on the runtime.

Availability of large-scale distributed computing systems and cloud computing platforms have caused creation of a relatively new art called DevOps, short for development operations. Generally, software engineers program an application and hand it over to DevOps teams for deployment of managed services on systems like cloud computing platforms. This approach of having two teams for development and delivery creates significant inefficiencies. In an ideal world, the developers of an application should be responsible for creation and subsequent delivery of the application as the developer of the application is the entity which should know the developed application the best.

In one embodiment, the present disclosure provides a method and system for developers of applications to program managed services to deliver the application and eliminate the role of DevOps in deploying and debugging the developed application.

Managed services are very helpful in that they help automate many repetitive tasks and offer many features which in the absence of a managed service would have to be programmed by the developers. However, managed services still have to be operated by individuals with expertise in the application. Consider a non-limiting example of MySQL managed service. The MySQL managed service helps automation of many tasks like deployment, scaling, backup, and restore. However, there are a plurality of usage patterns and use cases for MySQL. MySQL may need to be fine-tuned to work best for a given usage pattern and use case. Given that there are several thousand variables which may be tweaked to fine tune a MySQL cluster, tweaking MySQL for optimal performance is non-trivial. Moreover, many issues with MySQL require manual intervention by a skilled administrator. Likewise, there are numerous applications with a large number of variables which may be changed to fine tune the performance of an application. A lack of knowledge of available variables may lead to reduced performance or application crashes.

There may also be scenarios where applications crash due to many reasons including but not limited to bugs in the application, misconfigured settings, and hardware compatibility issues. Downtime due to application crashes may create a significant impact on businesses and may require manual intervention to recover the crashed application.

Further, tools for DevOps today are generally declaration-based which introduces several limitations and results in a loss of flexibility. Use cases like integration of machine learning or artificial intelligence to predict demand or predict application crashes may not be handled by declaration-based orchestration technologies.

In one embodiment, the present disclosure provides a method and system for programming and running autonomous services. The programmed autonomous services are capable of abstracting away most of the complexities associated with deploying and maintaining applications. The programmed autonomous services optionally offer features for auto configuring, auto scaling, auto recovering and automating all other aspects.

Runtimes, whether multi-tenant or single tenant, generally would support a very large number of managed services. Each of the managed services may be used to deploy one or more application instances and support workloads they are designed for. The applications may be of critical importance. Moreover, runtimes, whether single tenant or multi-tenant, may be running a plurality of applications which may be of critical importance. This makes the runtime or the multi-tenant platform a critical piece of infrastructure. It is important that the runtimes do not experience downtimes or cause downtime of applications running on the runtimes.

Further, runtimes are complex systems. Generally, systems of comparable complexity are very difficult to maintain and upgrade. Upgrading systems of comparable complexity generally requires a deep expertise of the system, meticulous planning and significant effort from the administrators. Despite all the effort, systems of comparable complexity generally experience downtime, either of the entire system or of the applications running on the system. Moreover, some updates may be critical and require immediate update to the running systems. Delays in applying critical updates may have potentially disastrous outcomes if the updates were related to security.

In addition, the updates may not be limited to a runtime or to the services running on the runtime; rather the updates may be related to the infrastructure or the host operating system.

In one embodiment, the present disclosure provides a method and system for live update of the system implementing general computing abstraction and enabling updates of the underlying infrastructure like the host operating system. The method and system enable near zero downtime of the system during the update. The method and system further enable managed services to achieve zero downtime of their applications during the update.

Thus, it can be seen that the methods and systems in accordance with the present disclosure provide a tenant application programming approach for building and consuming applications which is language, platform and infrastructure agnostic and which is simple for developers to build, distribute and maintain such applications. The approach enables developed applications to be able to run on heterogenous public clouds, platforms, and infrastructures. In addition, the developers are able to build applications in accordance with the present disclosure without having prior knowledge of the hardware, platform, infrastructure, cloud, data centers, fault tolerant zones, network configurations, and similar parameters and requirements of the environment that an application would eventually run on. The developed applications advantageously offer all the benefits of desktop, mobile and cloud applications while, at the same time, mitigate issues and security risks associated with developing applications for each of the categories. The approach in accordance with the present disclosure enables software engineers to develop complex SAAS applications with a plurality of dependencies very quickly. The approach also enables software engineers to use their existing skills to build PAAS and SAAS applications without having to learn new programming languages or technologies to build managed services. Further, the approach enables delivery of single tenant applications as PAAS and SAAS applications across heterogenous platforms and infrastructures without the need of re-writing the applications. In accordance with the present disclosure, the approach also enables users to use PAAS and SAAS applications privately on their own cloud accounts, data centers, devices (like laptops), or any private infrastructure and addresses the security concerns associated with the use of centrally hosted public PAAS and SAAS applications.

In accordance with the present disclosure, a language, platform and infrastructure agnostic approach is provided which offers users an ability to discover and consume SAAS and PAAS applications on their choice of infrastructure and platform with similar ease as they discover and consume mobile applications. The users are also beneficially enabled to run applications in the cloud without worrying about resource constraints associated with mobile computing devices. Developers are enabled to build and deploy cloud independent, platform independent and device independent applications and users are enabled to install and use SAAS and PAAS applications on any platform and infrastructure. In accordance with the present disclosure, automatic update of PAAS and SAAS applications is supported as well as reusability of PAAS and SAAS applications is facilitated for faster development of managed services. Autonomous applications can be developed, thereby eliminating or reducing the need for DevOps and empowering developers to monetize their PAAS and SAAS applications.

While exemplary embodiments have been presented in the foregoing detailed description, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment, it being understood that various changes may be made in the function and arrangement of steps and method of operation described in the exemplary embodiment without departing from the scope of the invention as set forth in the appended claims.

1. A method for platform and infrastructure agnostic programming comprising:
identifying a plurality of components and nodes to be utilized by an application runtime to implement logical entities and manage methods of a general computing abstraction;
generating an application manager to expose an interface to a user to interact with the application runtime as part of an application instance; and
programming the application manager to manage activities of the application instance, wherein the application manager uses logical entities of a general computing abstraction to create and manage the application instance.

2. The method of claim 1 wherein identifying the plurality of components and/or nodes comprises identifying container images corresponding to each of the plurality of components and/or nodes, and
wherein generating the application manager comprises generating the application manager to manage a plurality of containerized applications corresponding to the container images.

3. The method of claim 1 wherein identifying the plurality of components and/or nodes to be utilized by the application runtime comprises identifying an authentication and authorization service to be utilized by the application runtime.

4. The method of claim 1 wherein identifying the plurality of components and/or nodes to be utilized by the application runtime comprises identifying one or more of an infrastructure controller component, a network controller component, a database controller component, a snapshots controller component, a notifications component, or an exec controller component.

5. The method of claim 1 wherein identifying the plurality of components and/or nodes to be utilized by the application runtime comprises identifying one or more of a runtime application programming interface (API) server, a general computing abstraction API server, or a front end server.

6. The method of claim 1 wherein identifying the plurality of components and/or nodes to be utilized by the application runtime comprises identifying one or more of a runtime update manager or an application update manager.

7. The method of claim 1 wherein identifying the plurality of components and/or nodes to be utilized by the application runtime comprises identifying one or more of an application repository service, an invocation service, an object storage service, a metrics service, a time-based service, an encryption service, a secrets service, an image service or a billing service.

8. The method of claim 1 wherein identifying the plurality of components and/or nodes to be utilized by the application runtime comprises identifying one or more of an event watcher component or a resource watcher component.

9. The method of claim 1 wherein identifying the plurality of components and/or nodes to be utilized by the application runtime comprises identifying one or more of command line tools, a remote development component or an application installer component.

10. A general computing abstraction comprising:
logical entities; and
methods,
wherein the logical entities comprise one or more actions, and
wherein the one or more actions are configured to enable a user to develop platform and infrastructure agnostic applications to orchestrate the logical entities and manage the methods of the general computing abstraction.

11. The general computing abstraction of claim 10 wherein the platform and infrastructure agnostic applications include one or more application managers, and
wherein the one or more actions enable the user to develop the one or more application managers to invoke one or more runtimes, each of the one or more runtimes configured to implement the logical entities of the general computing abstraction in accordance with the methods of the general computing abstraction.

12. The general computing abstraction of claim 10 wherein the one or more actions further enable the user to publish the platform and infrastructure agnostic applications to an application registry.

13. The general computing abstraction of claim 10 wherein the one or more actions further enable the user to publish the platform and infrastructure agnostic applications to an application marketplace.

14. (canceled)

15. The general computing abstraction of claim 10 wherein the one or more actions of the logical entities comprise one or more deployments.

16. The general computing abstraction of claim 10 wherein the logical entities comprise one or more workers or worker groups, each of the one or more worker groups comprising one or more workers.

17. The general computing abstraction of claim 10 wherein the logical entities comprise one or more volumes, snapshots, objects, exec entities, logs, metrics or certificates, or a cron entity.

18. (canceled)

19. The general computing abstraction of claim 10 wherein the one or more actions of the logical entities comprise one or more networking, event, notification actions, image management actions or secrets management actions.

20. (canceled)

21. The general computing abstraction of claim 10 wherein the methods comprise security and encryption methods configured to facilitate the user to develop the platform and infrastructure agnostic applications.

22. The general computing abstraction of claim 10 wherein the methods comprise worker management and application release methods configured to facilitate the user to develop the platform and infrastructure agnostic applications.

23. The general computing abstraction of claim 10 wherein the methods comprise logs and telemetry, events and pricing methods configured to facilitate the user to develop the platform and infrastructure agnostic applications.
